(19) United States
(12) Patent Application Publication
(10) Pub. No.: US 2007/0110126 A1
(43) Pub. Date: May 17, 2007

(54) Radio communication system and communication apparatus

(75) Inventors: Hidenori Sekiguchi, Kawasaki (JP); Akira Fujii, Kawasaki (JP); Masafumi Asai, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/401,346

(22) Filed: Apr. 11, 2006

(30) Foreign Application Priority Data
Nov. 16, 2005 (JP) 2005-331990

(51) Int. Cl. H04B 1/00

(52) U.S. Cl. 375/130

(57) ABSTRACT

The communication apparatus employing the non-coherent scheme is used in the UWB-impulse radio system. In order to make it possible to reliably realize long-distance communication, while observing the reference values of the average radiation power and the peak radiation power, and also to realize high-speed short-distance communication, the apparatus includes an impulse adjusting unit which adjusts, according to the distance between two communication apparatuses detected by the distance detecting unit, the amplitude and the repetition frequency of impulses used in radio communication between the two communication apparatuses.

### BACKGROUND OF THE INVENTION

1) Field of the Invention

The present invention relates to an art for controlling the impulse amplitude and the impulse repetition frequency in an UWB (Ultra WideBand)-impulse radio apparatus (system) which uses extremely short impulse signals.

2) Description of the Related Art

Recently, studies for making a UWB (Ultra WideBand)-impulse radio system, in which an impulse signal is used in place of a carrier wave, suitable for practical use have been performed. This UWB-impulse radio communication uses an extremely short (approximately 1 ns) impulse signal (hereinafter also simply called impulses), without using a carrier wave, to perform communication.

This UWB-impulse radio communication has the following characteristic features (1) through (5):

(1) use of impulses makes the spectrum considerably wide, but it hardly interferes with other systems (radio communication) because of its low spectrum density;

(2) power transmission only performed at the time of impulse transmission reduces power consumption;

(3) use of a high band increases a transfer rate;

(4) impulses make it easy to separate multipath, and is thus highly resistant to multipath and fazing;

(5) detection of extremely short impulses realizes high distance measuring resolution.

The reception methods in UWB-impulse radio apparatuses employing the UWB-impulse radio system, as disclosed in the following patent document 1, include a coherent scheme (see FIG. 24 described below) and a non-coherent scheme (see FIG. 25 described below). In the coherent scheme, a pulse train is generated in synchronism with a transmission pulse train and a correlation operation is performed, thereby receiving data. In the non-coherent scheme, pulses are detected asynchronously with the transmission pulse, thereby receiving data.

Now, a description will be made hereinbelow of a reception apparatus 100 employing a coherent scheme with reference to FIG. 24. The reception apparatus 100 is capable of repeating (feedback) a correlation operation (integration processing) by a mixer 104, an integrator 105, a comparator 106, a baseband 107, and a PG (Pulse Generator) 108, onto an impulse signal which has been received through an antenna 101 and has passed through a BPF (Band Pass Filter) 102 and an LNA (Low Noise Amplifier) 103.

In this communication system employing the coherent method, if the reception apparatus lengthens the integration time by adjusting the time (integration time) during which the reception apparatus performs a correlation operation, or by adjusting the number of pulses per bit (that is, by increasing the number of repetition times of integration processing), the sensitivity (this is called a spread gain) is improved, so that long distance communication becomes available while the transfer rate is decreased.

Further, in such a communication system, if the reception apparatus shortens the integration time (that is, the number of repetition times integration processing is reduced), the sensitivity is decreased (a spread gain is not obtained), so that the transfer rate is increased while the communication distance is shortened.

However, the coherent scheme requiring a Phase Locked Loop (PLL) with respect to transmission pulses on the receiver end, will increase the size of the reception circuit. Further, a long preamble data is required until the synchronization is established, so that electric power unnecessary for data transmission is generated.

Next, referring to FIG. 25, a description will be made hereinbelow of a reception apparatus 110 employing the non-coherent scheme. The reception apparatus 110 includes: an operation 111 which performs energy detection by obtaining the square of an impulse signal which has been received through an antenna 101 and has passed through a BPF 102 and an LNA 103; a LPF (Low Pass Filter) 112; a comparator 106; and a baseband 107.

This non-coherent scheme detects impulses asynchronously with transmission pulses. Hence, the construction of a reception circuit of the reception apparatus 110 is simpler than that of the reception apparatus 100 employing the coherent scheme.

Further, since preamble data can be short in the non-coherent scheme, the scheme is suitable for use in small-sized, inexpensive, low power-consumption equipment.

In the coherent scheme, however, since only the presence or the absence of reception pulses is detected, it is necessary to enlarge the pulse amplitude for realizing long-distance communication.

In this instance, there has been an art for decreasing the pulse amplitude when the distance between communication apparatuses is short, to reduce unnecessary effects on other peripheral equipment (see the following patent document 1).

Generally speaking, radio laws define that the peak radiation power and the average radiation power of an impulse signal should be maintained equal to or lower than a specified power.

For example, the FCC (Federal Communications Commission) defines that in the UWB, as shown in FIG. 26, the average radiation power of impulses is smaller than −41.3 dBm/MHz inclusive in a range of 3.1 GHz through 10.6 GHz. In addition, the peak radiation power is defined to be −33.98 dBm/MHz (+0 dBm/MHz at a resolution of 50 MHz, and this value is obtained by a conversion formula at a resolution of 1 MHz). This is called an FCC mask.

When there is a regulation for the power of impulses such as the FCC mask, increase in pulse amplitude for long-distance communication can make the average radiation power exceed the reference value.

In addition, in the above-described non-coherent scheme, impulses are detected by energy detection without synchronization with transmission pulses. Thus, when the communication distance is long, the pulse amplitude needs to be sufficiently enlarged, so that the average radiation power can exceed its reference value.

Therefore, in the communication system employing the non-coherent scheme, when an impulse generation method is set on an assumption of long-distance communication, increase in pulse amplitude will necessitate decrease in pulse repetition frequency [pulse rate; PRF (Pulse Repetition Frequency)] to observe the reference value of the average radiation power. As a result, in such a communication system, the communication speed remains low even when the communication distance becomes short, so that the communication speed cannot be increased. In other words, if the pulse repetition frequency is decreased in order to observe the reference value of the average radiation power, the communication speed becomes slow irrespectively of the communication distance.

[Non-patent Document 1] Rick Roberts; “Harris TG4a CFP Proposal Response” [online], January 2005, IEEE (the Institute of Electrical and Electronic Engineers); [searched on Sep. 15, 2005], the Internet <URL:http://grouper.ieee.org/groups/802/15/pub/05/15-05-0006-01-004a-harris-cfp-response.ppt>

[Patent Document 1] Published Japanese Translation of a PCT application No. 2004-510388

### SUMMARY OF THE INVENTION

With the foregoing problems in view, one object of the present invention is to make it possible for communication apparatuses which employ the non-coherent scheme and which are used in communication systems employing the UWB-impulse radio communication method, to reliably realize long-distance communication while observing the reference values (the upper limit values) of the average radiation power and the peak radiation power. Another object of the invention is to realize high-speed communication in short-distance communication.

In order to accomplish the above objects, according to the present invention, there is provided a radio communication system including a plurality of communication apparatuses which are communicably connected with each other by radio under the UWB (Ultra WideBand)-impulse radio system, the radio communication system comprising: a distance detecting unit which detects the distance between two communication apparatuses, of the plurality of communication apparatuses, the two communication apparatuses being communicably connected by radio; and an impulse adjusting unit which adjusts the amplitude and the repetition frequency of impulses used in radio communication between the two communication apparatuses according to the distance detected by the distance detecting unit.

As a preferred feature, the impulse adjusting unit (i) reduces the repetition frequency when increasing the amplitude of the impulses according to the distance, and (ii) increases the repetition frequency of the impulses when reducing the amplitude of the impulses according to the distance.

As a generic feature, there is provided a radio communication system including a plurality of communication apparatuses which are communicably connected with each other by radio under the UWB (Ultra WideBand)-impulse radio system, the radio communication system comprising: an electric power detecting unit which detects electric power of impulses which are sent from one of the two communication apparatuses to be connected with each other, of the plurality of communication apparatuses, and which are received by the other of the two communication apparatuses; an impulse adjusting unit which adjusts the amplitude and the repetition frequency of impulses used in radio communication between the two communication apparatuses, according to the electric power detected by the power detecting unit.

As another generic feature, there is provided a radio communication system including a plurality of communication apparatuses which are communicably connected with each other by radio under the UWB (Ultra WideBand)-impulse radio system, the radio communication system comprising: a minimum amplitude detecting unit which detects the minimum amplitude of impulses which can be received by one of the two communication apparatuses to be communicably connected with each other by radio, of the plurality of communication apparatuses, the impulses being sent from the other of the two communication apparatuses; an impulse adjusting unit which adjusts the amplitude and the repetition frequency of impulses used in radio communication between the two communication apparatuses according to the minimum amplitude of impulses detected by the minimum amplitude detecting unit.

As yet another generic feature, there is provided a communication apparatus for use in a radio communication system in which communication is carried out under the UWB (Ultra WideBand)-impulse radio system, the apparatus comprising: a distance detecting unit which detects the distance from another communication apparatus with which communication is to be performed; and an impulse adjusting unit which adjusts the amplitude and the repetition frequency of impulses used in radio communication with the other communication apparatus according to the distance detected by the distance detecting unit.

In this manner, according to the present invention, the impulse adjusting unit adjusts the amplitude and the repetition frequency of impulses used in radio communication in accordance with the distance between the two communication apparatuses. Thus, even when the reception scheme used in these communication apparatuses is the non-coherent scheme, the repetition frequency of impulses is reduced when the amplitude of impulses is increased, so that the long-distance communication is reliably realized while observing the reference values (upper limits) of the average radiation power and the peak radiation power.

Further, since the impulse adjusting unit adjusts the amplitude and the repetition frequency of impulses, the amplitude of impulses can be reduced when the repetition frequency of impulses is increased, so that high-speed communication can be realized while the reference values are observed.

Other objects and further features of the present invention will be apparent from the following detailed description when read in conjunction with the accompanying drawings.

### BRIEF DESCRIPTION OF THE DRAWINGS

FIG. 1 is a block diagram showing a construction of a radio communication system according to a first embodiment of the present invention;

FIG. 2(a) through FIG. 2(c) are diagrams for describing adjustment processing of the amplitude and the repetition frequency of impulses according to the communication distance, which adjustment is carried out by an impulse adjusting unit of the radio communication system according to the first embodiment; FIG. 2(a) shows adjustment processing in a case of long distance communication; FIG. 2(b) shows adjustment processing in a case of intermediate distance communication; FIG. 2(c) shows adjustment processing in a case of short distance communication;

FIG. 3 is a diagram for describing communication processing using impulse signals in the radio communication system of the first embodiment of the present invention;

FIG. 4 is a block diagram showing a construction of one of the two communication apparatuses in the radio communication system of the first embodiment of the present invention;

FIG. 5 is a diagram showing a table held by a pulse determining unit of the communication apparatus of FIG. 4;

FIG. 6 is a diagram for describing a relationship between the repetition frequency of impulse signals for use in the present invention and radiation power;

FIG. 7 is a block diagram showing a construction of the other one of the two communication apparatuses in the radio communication system of the first embodiment of the present invention;

FIG. 8 is a diagram for describing processing procedures in the radio communication system of the first embodiment;

FIG. 9 is a diagram for describing a distance calculation method performed by a distance calculating unit (as a distance detecting unit) of the radio communication system of the first embodiment;

FIG. 10 is a block diagram showing a construction of a radio communication system according to a second embodiment of the present invention;

FIG. 11 is a block diagram showing a construction of one of the two communication apparatuses in the radio communication system of the second embodiment of the present invention;

FIG. 12 is a block diagram showing a construction of the other one of the two communication apparatuses in the radio communication system of the second embodiment of the present invention;

FIG. 13 is a table held by the communication apparatus shown in FIG. 12;

FIG. 14 is a diagram for describing processing procedures in the radio communication system of the second embodiment;

FIG. 15 is a block diagram showing a construction of a radio communication system according to a third embodiment of the present invention;

FIG. 16 is a block diagram showing a construction of one of the two communication apparatuses in the radio communication system of the third embodiment of the present invention;

FIG. 17 is a table held by the communication apparatus shown in FIG. 16;

FIG. 18 is a diagram for describing processing procedures in the radio communication system of the third embodiment;

FIG. 19 is a block diagram showing a construction of a radio communication system according to a fourth embodiment of the present invention;

FIG. 20 is a block diagram showing a construction of one of the two communication apparatuses in the radio communication system of the fourth embodiment of the present invention;

FIG. 21 is a table held by a pulse determining unit of the communication apparatus shown in FIG. 20;

FIG. 22 is a block diagram showing a construction of the other one of the two communication apparatuses in the radio communication system of the fourth embodiment of the present invention;

FIG. 23 is a diagram for describing processing procedures in the radio communication system of the fourth embodiment;

FIG. 24 is a block diagram showing a construction of a receiving apparatus which employs a previous coherent scheme;

FIG. 25 is a block diagram showing a construction of a receiving apparatus which employs a previous non-coherent scheme; and

FIG. 26 is a diagram for describing the requirements (FCC mask) of average radiation power and peak radiation power of impulses in the UWB (Ultra WideBand) according to the FCC (Federal Communications Commission).

### DESCRIPTION OF THE PREFERRED EMBODIMENT(S)

Embodiments of the present invention will now be described with reference to the accompanying relevant drawings.

### [1] First Embodiment

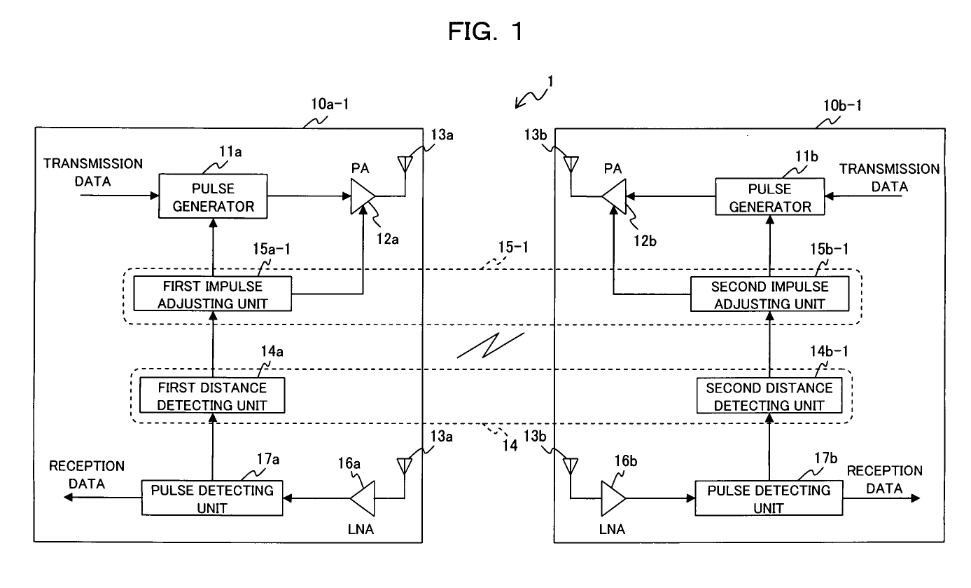

First of all, referring to the block diagram of FIG. 1, a description will be made hereinbelow of a construction of a radio communication system according to a first embodiment of the present invention. As shown in FIG. 1, the present radio communication system 1 includes multiple (here, two) communication apparatuses [UWB (Ultra WideBand)-impulse radio apparatuses] 10a-1 and 10b-1, which are communicably connected with one another by radio under the UWB-impulse radio communication scheme.

The communication apparatus 10a-1 includes: a pulse generator 11a which generates impulses (impulse signal) based on transmission data; a PA (Power Amplifier) 12a which amplifies the impulses generated by the pulse generator 11a; and an antenna 13a which sends out the impulses having been amplified by the PA 12a.

Further, the communication apparatus 10a-1 also includes: an LNA (Low Noise Amplifier) 16a which amplifies impulses received from a communication apparatus 10b-1 through the antenna 13a, the communication apparatus 10a-1; and a pulse detecting unit 17a which detects the impulses amplified by the LNA 16a l as reception data.

The communication apparatus 10b-1 has a construction similar to the communication apparatus 10a-1. That is, a pulse generating unit 11b, a PA 12b, an antenna 13b, an LNA 16b, and a pulse detecting unit 17b, of a communication apparatus 10b-1 correspond to the pulse generator 11a, the PA 12a, the antenna 13a, the LNA 16a, and the pulse detecting unit 17a, respectively, of the communication apparatus 10a-1, and have functions similar to those of the corresponding elements.

The radio communication system 1 includes: a distance detecting unit (distance measuring unit) 14 which detects (measures) the distance between the communication apparatuses 10a-1 and 10b-1; and an impulse adjusting unit 15-1 which adjusts (i) impulse amplitude (hereafter also simply called amplitude or pulse amplitude) and (ii) impulse repetition frequency [pulse rate; hereafter also called repetition frequency, pulse repetition frequency, and PRF (Pulse Repetition Frequency)] of impulses used in radio communication between the communication apparatuses 10a-1 and 10b-1, based on the distance between the communication apparatus 10a-1 and communication apparatus 10b-1 detected by the distance detecting unit 14.

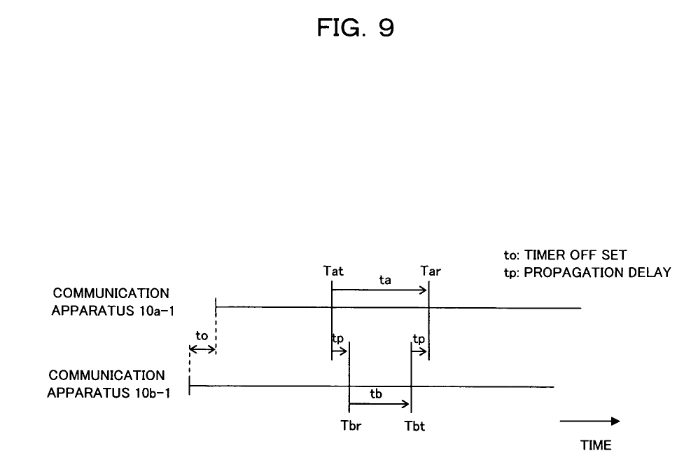

The distance detecting unit 14-1 has a first distance detecting unit 14a of the communication apparatus 10a-1 and a second distance detecting unit 14b-1 of the communication apparatus 10b-1. The distance detecting unit 14-1 detects the distance between the communication apparatuses 10a-1 and 10b-1 based on a propagation time which is required for impulses to travel therebetween. The method for detecting this distance will be detailed later with reference to FIG. 9.

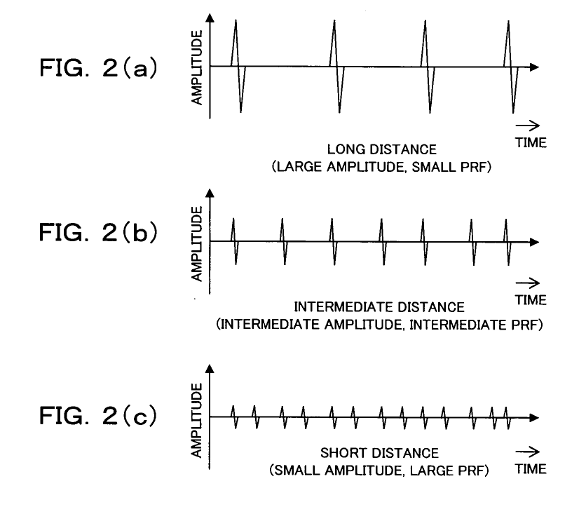

The impulse adjusting unit 15-1 has a first impulse adjusting unit 15a-1 of the communication apparatus 10a-1 and a second impulse adjusting unit 15b-1. As shown in FIG. 2(a), for example, if the distance detected by the distance detecting unit 14 is long, the impulse adjusting unit 15-1 performs adjustment so that the amplitude of impulses is large and that the repetition frequency of impulses is low.

Further, as shown in FIG. 2(b), if the distance detected by the distance detecting unit 14 is intermediate, the impulse adjusting unit 15-1 performs adjustment so that the amplitude of impulses is smaller than that when the distance is long and that the repetition frequency of impulses is higher than that when the distance is long.

In addition, as shown in FIG. 2(c), if the distance measured by the distance detecting unit 14 is short, the impulse adjusting unit 15-1 performs adjustment so that the amplitude of impulses is smaller than that when the distance is intermediate and that the repetition frequency of impulses is higher than that when the distance is intermediate.

In this manner, the impulse adjusting unit 15-1 adjusts the amplitude and the repetition frequency of impulses according to the distance measured by the distance detecting unit 14. That is, as shown FIG. 2(a) through FIG. 2(c), the impulse adjusting unit 15-1 reduces the repetition frequency when increasing the amplitude of impulses according to the distance. On the other hand, the impulse adjusting unit 15-1 increases the repetition frequency when reducing the amplitude of impulses according to the distance. As a result, it becomes possible to reliably realize communication regardless of the distance, while suppressing a peak radiation power and an average radiation power under a specified value (for example, the FCC mask). Further, in the case of a short distance, the communication speed can be increased.

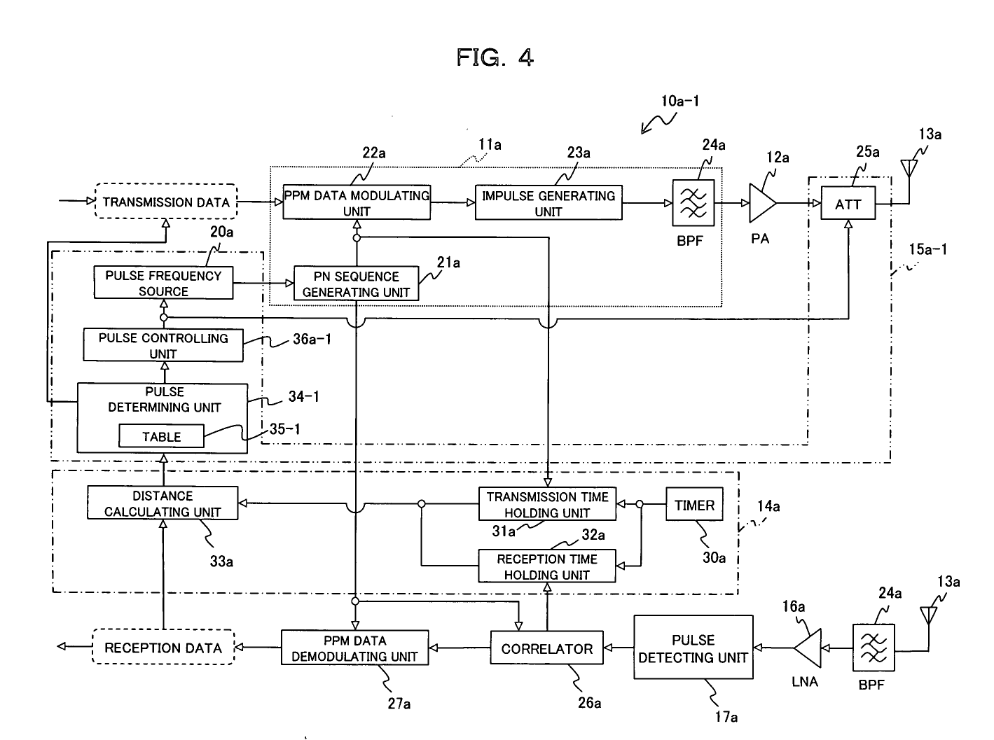

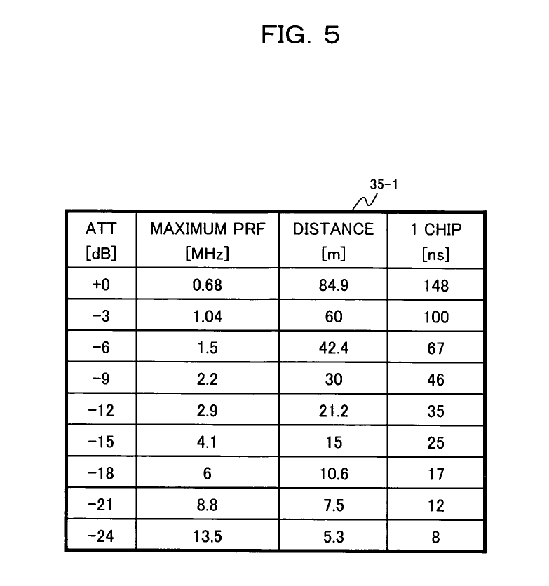

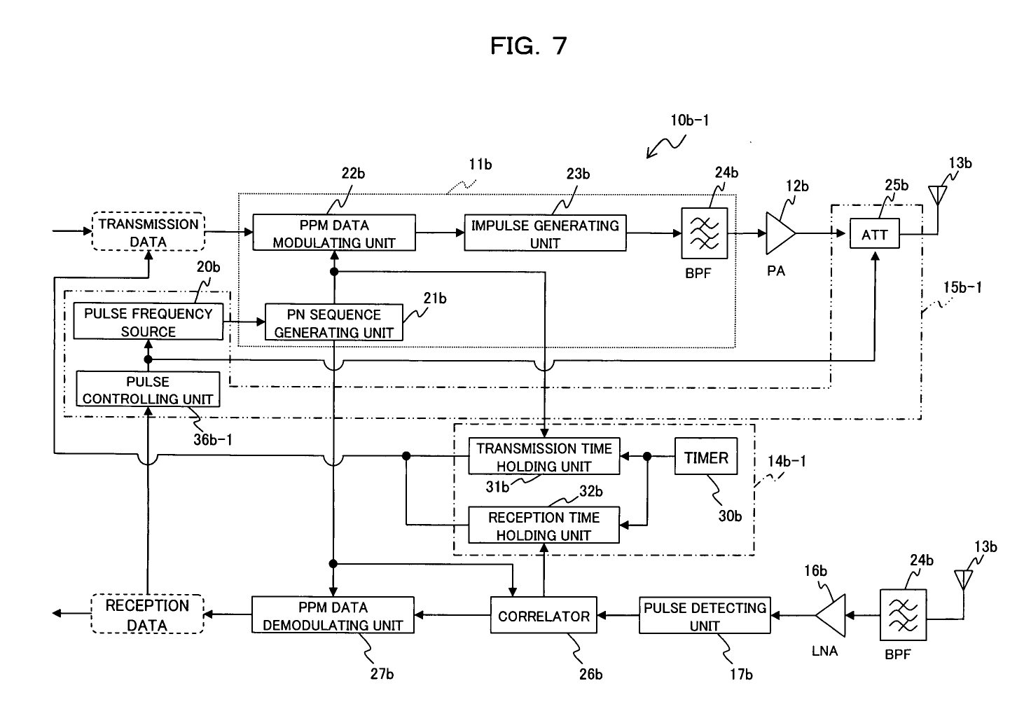

A concrete construction of the impulse adjusting unit 15-1 will be detailed later with reference to FIG. 4, FIG. 5, and FIG. 7.

In this instance, in the radio communication system 1, the distance detecting unit 14 and a part [a pulse determining unit 34 (will be detailed later) of FIG. 4] of the impulse adjusting unit 15-1 which determines the amplitude and the repetition frequency is provided for the communication apparatus 10a-1, but they can be provided for the communication apparatus 10b-1, or for both of the communication apparatus 10a-1 and the communication apparatus 10b-1.

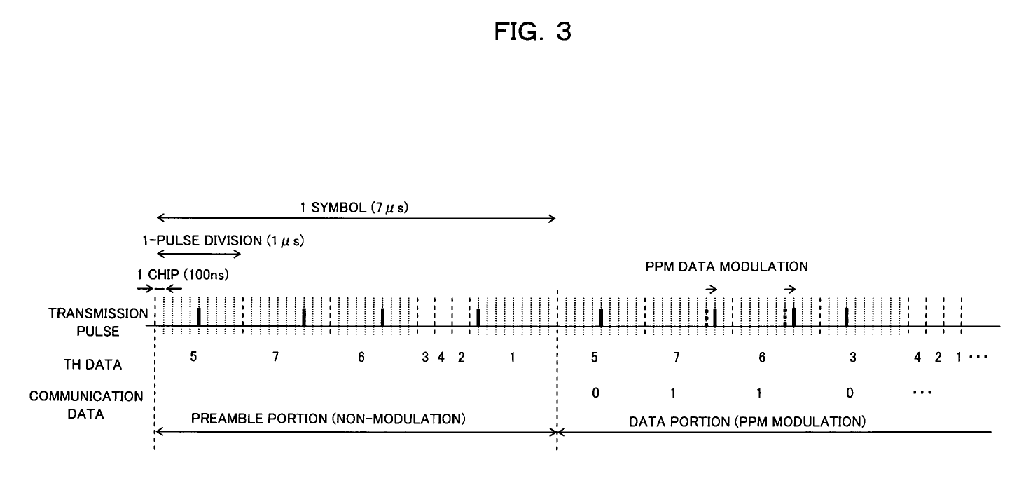

Here, referring to FIG. 3, a description will be made hereinbelow of the data transceiving method (the UWB-impulse radio system) between the communication apparatuses 10a-1 and 10b-1 of the radio communication system 1, in which method impulses are used for transceiving data.

As shown in FIG. 3, transmission data in the radio communication system 1 is time-hopped by 8-value (that is, eight values from 0 through 7) RS (Reed-Solomon) sequence, which is a kind of PN (Pseudo Noise) sequence, and also is data-modulated by Pulse Position Modulation (PPM).

In cases where the minimum time unit for changing the pulse position, 1 chip, is 100 ns, if “5763421” is used as the RS sequence, in seven pulse divisions [equal to 1 symbol (7, s)] (1 pulse division is 1,s) of a preamble portion (data is not modulated) for synchronization of transmission data (TH data), the initial pulse is time-hopped at the position of 500 ns; the next pulse, at 700 ns; the next pulse, at 600 ns; the next pulse, at 300 ns; the next pulse, at 400 ns; the next pulse, at 200 ns; the next pulse, at 100 ns.

Here, in FIG. 3, for simplification of illustration, the 4th to the 6th symbols from the leading end (the left end in the drawing) of the preamble portion not shown. Further, in FIG. 3, the vertical thick solid line indicates that pulses are time-hopped.

Likewise, the data portion (communication data) following the preamble portion is time-hopped by the RS sequence. When “1” is indicated in each pulse division of the data portion, a pulse is shifted backwards by one chip in comparison with the position time-hopped in the preamble portion. Thus, so-called pulse position modulation is performed.

For example, the data portion is “0110000”, the RS sequence of “5763421” indicated by the preamble portion is modulated into “5873421” in the data portion. In the seven pulse divisions, the initial pulse is time-hopped at the position of 500 ns; the next pulse, at 800 ns; the next pulse, 700 ns; the next pulse, at 300 ns; the next pulse, 400 ns; the next pulse, at 200 ns; the next pulse, at 100 ns.

That is, in the second pulse division indicating “1”, the pulse is hopped at the position of 700 ns in the preamble portion, while the pulse is hopped at the position of 800 ns (backwards by one chip) in the data portion. Likewise, in the third pulse division indicating “1”, the pulse is hopped at the position of 600 ns in the preamble portion, while the pulse is hopped at the position of 700 ns (backwards by one chip) in the data portion. In FIG. 3, for the simplification of illustration, the 5th through the 7th symbols from the leading end of the data portion are omitted.

Next, referring to the block diagram of FIG. 4, a description will be made more in detail of a construction of the communication apparatus 10a-1 of the radio communication system 1. In FIG. 4, like reference characters designate the same or the similar elements already described.

As shown in FIG. 4, the communication apparatus 10a-1 has the above-described PA 12a, antenna 13a, LNA 16a, and pulse detecting unit 17a. In addition, the communication apparatus 10a-1 includes: a pulse frequency source 20a; a PN sequence generating unit 21a; a PPM data modulating unit 22a; an impulse generating unit 23a; a BPF (Band Pass Filter) 24a; an ATT (attenuator) 25a; a correlator 26a; a PPM data modulating unit 27a; a timer 30a; a transmission time holding unit 31a; a reception time holding unit 32a; a distance calculating unit 33a; a pulse determining unit 34-1; and a pulse controlling unit 36a-1.

On the communication apparatus 10a-1, a clock of 10 MHz (100 ns cycle) is generated by the pulse frequency source 20a. On the basis of the clock, the PN sequence generating unit 21a generates the above-described RS sequence.

The PPM data modulating unit 22a performs PPM modulation according to whether transmission data is “1” or “0”, and pulses are sent to the impulse generating unit 23a.

The impulse generating unit 23a, for example, generates extremely fine impulses at the rise of pulses using a step recovery diode.

The BPF 24a removes unnecessary spectrum of the impulses generated by the impulse generating unit 23a.

That is, the impulses generated by the impulse generating unit 23a have a significantly wide band. However, for the purpose of making the impulse adapt to the FCC mask, the impulses generated by the impulse generating unit 23a are made to pass through the BPF 24a of 3.1 GHz through 10.6 GHz, so that unnecessary spectrum lower than 3.1 GHz or higher than 10.6 GHz are removed.

Then, impulses which have passed through the BPF 24a are amplified by the PA 12a, and are attenuated by the ATT 25a as necessary, and are then radiated from the antenna 13a.

In this manner, in the communication apparatus 10a-1, the PN sequence generating unit 21a, the PPM data modulating unit 22a, the impulse generating unit 23a, and the BPF 24a function as a pulse generator 11a.

On the receiver end of the communication apparatus 10a-1, the BPF 24a removes unnecessary spectrum from impulse waves (that is, impulses sent from the communication apparatus 10b-1) received through the antenna 13a, and then the LNA 16a amplifies the impulse waves.

The pulse detecting unit 17a detects pulses from the impulses waves amplified by the LNA 16a.

This pulse detecting unit 17a has an envelop detecting circuit (not illustrated) formed by a diode and a comparator (not illustrated). The communication apparatuses 10a-1 and 10b-1 employ the non-coherent scheme as a reception scheme.

Further, the pulse detected by the pulse detecting unit 17a is input to the correlator 26a.

The correlator 26a compares the pulses detected by the pulse detecting unit 17a with the RS sequence generated by the PN sequence generating unit 21a, thereby detecting a preamble portion from the pulses.

The correlator 26a, which includes, for example, a digital matched filter (not illustrated), monitors matching (correlation) between the pulses and the RS sequence, to extract a preamble portion from the pulses.

When the preamble portion is detected by the correlator 26a, it is regarded that synchronization is established, and the PPM data modulating unit 27a demodulates the PPM of the data portion following the preamble, thereby generating reception data.

As shown in FIG. 4, the communication apparatus 10a-1 includes a timer 30a. At the time (initial setting time) the amplitude and the repetition frequency of impulses used in radio communication between the communication apparatus 10a-1 and the communication apparatus 10b-1 are initially determined and set [a distance measuring command (will be described later) is sent to the communication apparatus 10b-1], the transmission time holding unit 31a holds the time when the PN sequence generating unit 21a generates the first pulse of the data portion following the preamble portion transmitted to the communication apparatus 10b-1, based on the timer 30a.

Further, at the initial setting time, when the communication apparatus 10a-1 receives data (Tb; described later) relating to a time from the communication apparatus 10b-1, the reception time holding unit 32a of the communication apparatus 10a-1 holds the time when the pulse detecting unit 17a detects the initial pulse of the data portion of the data, based on the timer 30a.

After that, the distance calculating unit 33a calculates the distance between the communication apparatus 10a-1 and the communication apparatus 10b-1, based on the time held in the transmission time holding unit 31a, the time held in the reception time holding unit 32a, and the data (Tb; described later) relating to the time received from the communication apparatus 10b-1. The method of calculation of the distance by the distance calculating unit 33a will be detailed later with reference to FIG. 9.

In this manner, in the communication apparatus 10a-1, the timer 30a, the transmission time holding unit 31a, the reception time holding unit 32a, and the distance calculating unit 33a, function as a first distance detecting unit 14a.

Further, as shown in FIG. 4, in the communication apparatus 10a-1, after calculation of the distance by the distance calculating unit 33a, the pulse determining unit 34-1 determines the amplitude and the repetition frequency used in radio communication between the communication apparatus 10a-1 and the communication apparatus 10b-1.

The pulse determining unit 34-1 has a table 35-1, as shown in FIG. 5, in which the amplitude and the repetition frequency of impulses are associated. Based on the table 35-1, the amplitude and the repetition frequency are determined.

In this instance, the table 35-1 holds set values [power attenuation amount (rate); here, 9 stages of set values of “+0 dB”, “−3 dB”, “−6 dB”, “−9 dB”, “−15 dB”, “−18 dB”, “−21 dB”, and “−24 dB”] of ATT 25a as the amplitude of impulses, and also holds the maximum PRF as the repetition frequency of impulses. In addition, the table 35-1 also holds the 1-chip time (the value of 1 chip) in the pulse frequency source 20a corresponding to the maximum PRF.

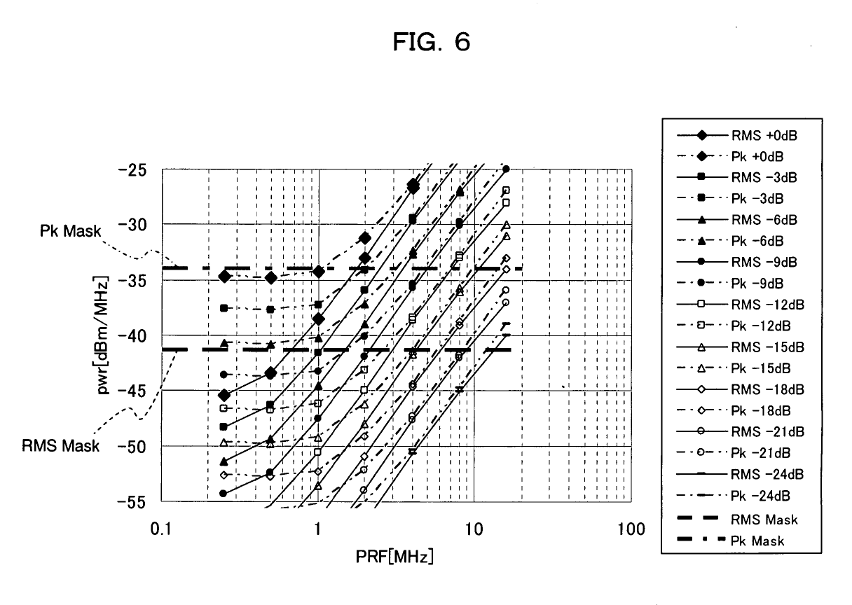

Here, a description will be made hereinbelow of a relationship between the pulse repetition frequency and the radiation power. FIG. 6 shows the result of measurement, by a spectrum analyzer, of an average radiation power (solid line designated by “RMS” in the note field) and a peak radiation power (two-dotted line designated by “Pk” in the note field), when the pulse repetition frequency (PRF) is changed according to nine stages of ATT 25a. In this instance, the average radiation power is measured by the RMS detecting function of the spectrum analyzer; the peak radiation power is measured by the peak detection function of the spectrum analyzer.

When requirements such as the FCC mask are taken into consideration in communication between the communication apparatuses 10a-1 and 10b-1, it is ideal that increase in pulse frequency will not cause the peak radiation power to increase. However, in the practical spectrum analyzer, when the frequency exceeds a certain level, the peak radiation power increases as the pulse repetition frequency increases.

Further, the average radiation power increases as the pulse repetition frequency increases.

With the FCC mask, the upper limit of the average radiation power (RMS Mask) is −41.3 dB/MHz, and the upper limit of the peak radiation power (Pk Mask) is −33.98 dBm/MHz. Thus, in the radio communication system 1, to suppress such powers under the above-mentioned upper limits, the impulse repetition frequency due to the pulse frequency source 20a and the power attenuation amount (here, nine stages of set values) due to the ATT 25a must be subjected to adjustment.

Accordingly, the table 35-1 is set so that it satisfies the reference values of the average radiation power and the reference values of the peak radiation power shown in FIG. 6.

That is, as shown in FIG. 5, when the attenuation of ATT 25a is not present (“+0 dB”) in the table 35-1, the amplitude of impulses is set so that the peak radiation power is the upper limit of the reference values. Here, on the basis of FIG. 6, when the pulse repetition frequency (PRF) exceeds 0.68 MHz, the average radiation power exceeds the reference value of the average radiation power. Thus, the maximum PRF is set to 0.68 MHz, and the 1-chip time due to the pulse frequency source 20a is set to 148 ns. With such setting, the communication apparatuses 10a-1 and 10b-1 are capable of communicating with each other at a distance of 84.9 m therebetween.

When the power attenuation amount of ATT 25a is “−3 dB”, the maximum PRF is 1.04 MHz, and the 1-chip time due to the pulse frequency source 20a is 100 ns. At this time, the maximum communication distance between the communication apparatuses 10a-1 and 10b-1 is 60 m.

Further, when the power attenuation amount of ATT 25a is “−6 dB”, the maximum PRF is 1.5 MHz, and the 1-chip time due to the pulse frequency source 20a is 67 ns. At this time, the maximum communication distance between the communication apparatuses 10a-1 and 10b-1 is 42.4 m.

Still further, when the power attenuation amount of ATT 25a is “−9 dB”, the maximum PRF is 2.2 MHz, and the 1-chip time due to the pulse frequency source 20a is 46 ns. At this time, the maximum communication distance between the communication apparatuses 10a-1 and 10b-1 is 30 m.

Furthermore, when the power attenuation amount of ATT 25a is “−12 dB”, the maximum PRF is 2.9 MHz, and the 1-chip time due to the pulse frequency source 20a is 35 ns. At this time, the maximum communication distance between the communication apparatuses 10a-1 and 10b-1 is 21.2 m.

Further, when the power attenuation amount of ATT 25a is “−15 dB”, the maximum PRF is 4.1 MHz, and the 1-chip time due to the pulse frequency source 20a is 25 ns. At this time, the maximum communication distance between the communication apparatuses 10a-1 and 10b-1 is 15 m.

Still further, when the power attenuation amount of ATT 25a is “−18 dB”, the maximum PRF is 6.0 MHz, and the 1-chip time due to the pulse frequency source 20a is 17 ns. At this time, the maximum communication distance between the communication apparatuses 10a-1 and 10b-1 is 10.6 m.

Furthermore, when the power attenuation amount of ATT 25a is “−21 dB”, the maximum PRF is 8.8 MHz, and the 1-chip time due to the pulse frequency source 20a is 12 ns. At this time, the maximum communication distance between the communication apparatuses 10a-1 and 10b-1 is 7.5 m.

Further, when the power attenuation amount of ATT 25a is “−24 dB”, the maximum PRF is 13.5 MHz, and the 1-chip time due to the pulse frequency source 20a is 8 ns. At this time, the maximum communication distance between the communication apparatuses 10a-1 and 10b-1 is 5.3 m.

Here, a description will be made hereinbelow of a concrete method of determining the amplitude and the repetition frequency of impulses by the pulse determining unit 34-1 using the table 35-1. For example, if the distance between the communication apparatuses 10a-1 and 10b-1 measured by the distance calculating unit 33a is 60 m, the pulse determining unit 34-1 sets the power attenuation amount of ATT 25a as the amplitude of impulses to “+0 dB”, and sets the pulse repetition frequency to a value equal to or smaller than 0.68 MHz. Concretely, since the pulse cycle is 1/0.68 MHz=1.47, s, the 1-chip time due to a clock generated by the pulse frequency source 20a corresponding to the pulse repetition frequency of 0.68 MHz is setto 148 ns. As a result, the 1-pulse division becomes 1.48, s, and the PRF becomes 1/1.48, s=0.68 MHz.

Likewise, when the distance calculated by the distance calculating unit 33a is equal to or greater than 42.4 m, the pulse determining unit 34-1 sets the power attenuation amount of ATT 25a to “−3 dB” based on the table 35-1. Further, to make the pulse repetition frequency equal to or lower than 1.04 MHz, the pulse determining unit 34-1 sets the 1-chip time which is based on the clock generated by the pulse frequency source 20a to 100 ns.

Further, when the distance calculated by the distance calculating unit 33a is shorter than 7.5 m, the pulse determining unit 34-1 sets the power attenuation amount of ATT 25a to “−24 dB” based on the table 35-1. Further, the pulse determining unit 34-1 also sets the 1-chip time to 8 ns.

Here, in the present invention, values in the table 35-1 of FIG. 5 are not limited to the present example. For example, the maximum PRF of the table 35-1 merely shows the maximum value of PRF. Thus, if the pulse frequency source 20a is only capable of changing the chip-time in 5 ns units, the 1-chip time when the maximum PRF is 0.68 MHz is changed from 148 ns to 150 ns. Likewise, the 1-chip time can be changed into 100 ns, 70 ns, 50 ns, 35 ns, 25 ns, 20 ns, 15 ns, and 10 ns.

As described so far, the radio communication system 1 sets the amplitude and the repetition frequency of impulses based on the table 35-1, thereby realizing a communication distance of 84.9 m at maximum and also realizing the high-speed communication at a rate of 13.5 MHz at maximum.

In addition, as shown in FIG. 4, a pulse controlling unit 36a-1 sets the attenuation amount of the ATT 25a based on the amplitude (here, the set value of the ATT 25a) determined by the pulse determining unit 34-1.

Further, the pulse controlling unit 36a-1 sets the PRF of the pulse frequency source 20a based on the repetition frequency of impulses determined by the pulse determining unit 34-1 so that the above-mentioned repetition frequency is realized.

That is, the pulse controlling unit 36a-1 controls the pulse frequency source 20a and the ATT 25a so that the amplitude and the repetition frequency of impulses determined by the pulse determining unit 34-1 are transmitted.

In this manner, in the communication apparatus 10a-1, the pulse determining unit 34-1, the pulse controlling unit 36a-1, the pulse frequency source 20a, and the ATT 25a function as a first impulse adjusting unit 15a-1.

Next, referring to the block diagram of FIG. 7, a description will be made in more detail hereinbelow of a construction of the communication apparatus 10b-1 of the radio communication system 1. Here, in FIG. 7, like reference characters designate the same or similar elements already described.

Further, in FIG. 7, elements designated by reference characters whose two numeric characters on the left are the same as those of the reference characters in FIG. 4 are constituents having the same or approximately the same functions.

As shown in FIG. 7, the communication apparatus 10b-1 includes the PA 12b, the antenna 13b, the LNA 16b, and the pulse detecting unit 17b, shown in FIG. 1. In addition, the communication apparatus 10b-1 includes: a pulse frequency source 20b; a PN sequence generator 21b; a PPM data modulating unit 22b; an impulse generating unit 23b; a BPF 24b; an ATT 25b; a correlator 26b; a PPM data demodulating unit 27b; a timer 30b; a transmission time holding unit 31b; a reception time holding unit 32b; and a pulse controlling unit 36b-1.

Here, the communication apparatus 10b-1 does not include elements equivalent to the distance calculating unit 33a and the pulse determining unit 34-1 of the communication apparatus 10a-1.

Further, the pulse frequency source 20b, the PN sequence generator 21b, the PPM data modulating unit 22b, the impulse generating unit 23b, the BPF 24b, the ATT 25b, the correlator 26b the PPM data demodulating unit 27b, and the timer 30b, have functions similar to those of the pulse frequency source 20a, the PN sequence generating unit 21a, the PPM data modulating unit 22a, the impulse generating unit 23a, the BPF 24a, the ATT 25a, the correlator 26a, the PPM data modulating unit 27a, and the timer 30a, respectively, of the communication apparatus 10a-1. Thus, a detailed description of the above elements is omitted.

Here, a description will be made of constituents (the transmission time holding unit 31b, the reception time holding unit 32b, and the pulse controlling unit 36b-1) of the communication apparatus 10b-1 which carry out operations different from those of the communication apparatus 10a-1.

Upon receipt of a distance measurement command sent from the communication apparatus 10a-1 at the initial setting time, on the communication apparatus 10b-1, the reception time holding unit 32b holds the time when the pulse detecting unit 17b detects the initial pulse of the data portion of the received data, based on the timer 30b.

Further, on the communication apparatus 10b-1, when sending back a response, meaning that such received data (the distance measurement command) has been received, to the communication apparatus 10a-1, the transmission time holding unit 31b holds the time when the PN sequence generator 21b generates the initial pulse of the data portion of transmission data as the response, based on timer 30b.

In this manner, in the communication apparatus 10b-1, the timer 30b, the transmission time holding unit 31b, and the reception time holding unit 32b function as a second distance detecting unit 14b-1.

The communication apparatus 10b-1 transmits the time held in the transmission time holding unit 31b and the time held in the reception time holding unit 32b or the difference therebetween calculated, to the communication apparatus 10a-1 as transmission data.

The pulse controlling unit 36b-1 of the communication apparatus 10b-1 controls the pulse frequency source 20b and the ATT 25b based on the amplitude and the repetition frequency of impulses which are determined by the pulse determining unit 34-1 of the communication apparatus 10a-1 and received from the communication apparatus 10a-1 as received data.

In this manner, in the communication apparatus 10b-1, the pulse frequency source 20b, the ATT 25b, and the pulse controlling unit 36b-1, function as a second impulse adjusting unit 15b-1.

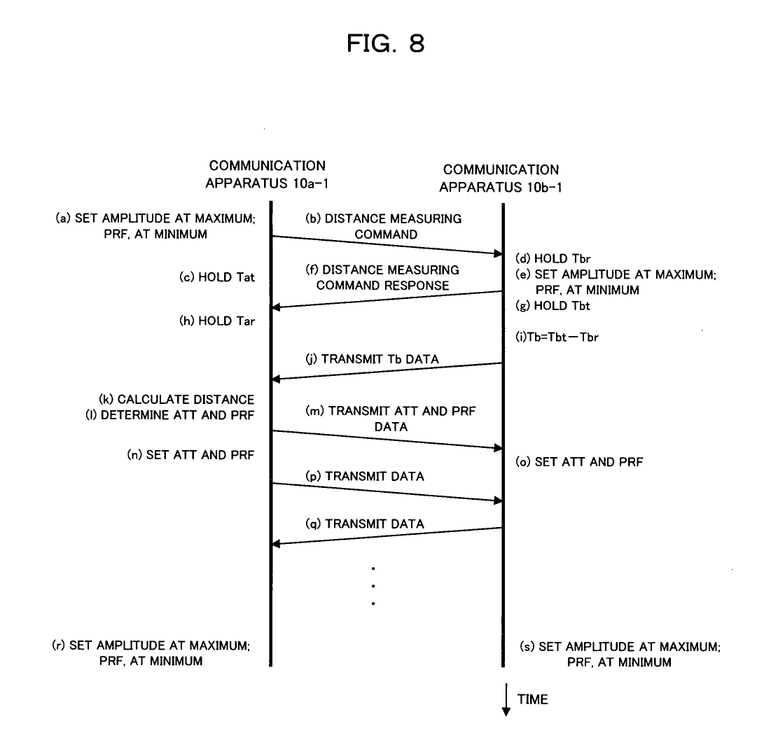

Next, referring to FIG. 8, a description will be made hereinbelow of a processing procedure (that is, communication procedures between the communication apparatuses 10a-1 and 10b-1).

When the communication apparatus 10a-1 communicates with the communication apparatus 10b-1, an initial setting operation [see (a) through (o) in FIG. 8] for determining the amplitude and the repetition frequency used in radio communication therebetween is executed.

The communication apparatus 10a-1 sets the amplitude of impulses used at the time of initial setting to a maximum value, and sets the repetition frequency of impulses to a minimum value [see (a) of FIG. 8]. That is, the pulse controlling unit 36a-1 controls the ATT 25a to have a power attenuation amount of “+0 dB”, thereby realizing the maximum pulse amplitude which can be generated by the communication apparatus 10a-1. Further, the pulse controlling unit 36a-1 controls the pulse frequency source 20a to realize the minimum repetition frequency (here, 1-chip is 148 ns) which can be generated by the pulse frequency source 20a.

Next, the communication apparatus 10a-1 sends a distance measurement command for measuring the distance from the communication apparatus 10b-1 with which communication is to be performed using the maximum amplitude and the minimum repetition frequency [see FIG. 8(b)].

At this time, the transmission time holding unit 31a of the communication apparatus 10a-1 holds the time (Tat) when the PN sequence generating unit 21a generates the initial pulse immediately after the preamble portion of the distance measuring command (that is, the initial pulse of the data portion), based on the timer 30a [see (c) of FIG. 8].

Then, when the communication apparatus 10b-1 receives the distance measuring command, the reception time holding unit 32b of the communication apparatus 10b-1 holds the time (the arrival time of a distance measuring time; Tbr) when the pulse detecting unit 17b detects the initial pulse after the preamble portion of the distance measuring command, based on the timer 30b [see (d) of FIG. 8].

After that, as in the case of procedure (a) in the communication apparatus 10a-1, the pulse controlling unit 36b-1 of the communication apparatus 10b-1 sets the amplitude of impulses to the maximum value (sets ATT 25b to “+0 dB”), and also sets the repetition frequency of impulses to the minimum value (1 chip is 148 ns) by controlling the pulse frequency source 20b [see (e) of FIG. 8].

The communication apparatus 10b-1 transmits the response (distance measurement command response) to the distance measuring command to the communication apparatus 10a-1 [see (f) of FIG. 8].

In this instance, the transmission time holding unit 31b of the communication apparatus 10b-1 holds the time (Tbt) when the PN sequence generator 21b generates the initial pulse (of the data portion) immediately after the preamble portion of the distance measurement command response, based on the timer 30b.

After that, when the communication apparatus 10a-1 receives the distance measurement command response from the communication apparatus 10b-1 as received data, the reception time holding unit 32a of the communication apparatus 10a-1 holds the time when the pulse detecting unit 17a detects the initial pulse immediately after the preamble portion of the distance measuring command (arrival time of the distance measuring command; Tar), based on the timer 30a [see (h) of FIG. 8].

In parallel with this processing (h), in the communication apparatus 10b-1, an operation unit (not illustrated) subtracts Tbr held in the reception time holding unit 32b from Tbt held in the transmission time holding unit 31b, thereby calculating the difference Tb [see (i) of FIG. 8].

Then, the communication apparatus 10b-1 transmits the difference Tb to the communication apparatus 10a-1 [see (j) of FIG. 8].

When the communication apparatus 10a-1 receives the difference Tb from the communication apparatus 10b-1, the distance calculating unit 33a calculates the distance between the communication apparatuses 10a-1 and 10b-1 [see (k) of FIG. 8].

The distance calculating unit 33a measures the distance between the communication apparatuses 10a-1 and 10b-1 with the TWR (Two Way Ranging) scheme. Here, referring to FIG. 9, a description will be made here in below of a concrete distance calculation method by the distance calculating unit 33a. First of all, it is assumed that the timer 30a held in the communication apparatus 10a-1 differs in time from the timer 30b of the communication apparatus 10b-1 by to.

This is because complete synchronization between the timer 30a and the timer 30b is practically unavailable, because such complete synchronization can be realized by super-accurate atomic clocks.

Assuming that the propagation time of impulses (radio wave) is given as tp, the following equations (1) and (2) are held based on (i) the time Tat when the communication apparatus 10a-1 transmits a distance measurement command (that is, the time held by the transmission time holding unit 31a), (ii) the time Tbr when the communication apparatus 10b-1 receives the distance measurement command (that is, the time held by the reception time holding unit 32b), (iii) the time Tbt when the communication apparatus 10b-1 transmits a distance measurement command response (that is, the time held by the transmission time holding unit 31b), and (iv) the time Tar when the communication apparatus 10a-1 receives the distance measurement command response (that is, the time held by the reception time holding unit 32a).
Tbr=Tat+to+tp (1)
Tat=Tbr+to−tp (2)

When these equations are solved for tp, the following equation (3) is obtained.
tp={(Tar−Tat)−(Tbt−Tbr)}/2=(Ta−Tb)/2 (3)

In the above equation (3), Ta=Tar−Tat and Tb=Tbt−Tbr.

Accordingly, the distance calculating unit 33a calculates the propagation time tp of impulses between the communication apparatuses 10a-1 and 10b-1 from the above equation (3) based on the Ta, which is the difference between Tar held by the reception time holding unit 32a and Tat held by the transmission time holding unit 31a, and on Tb, which is received from the communication apparatus 10b-1. Further, on the basis of the following equation (4), the distance calculating unit 33a calculates the distance Lab between the communication apparatus 10a-1 and the communication apparatus 10b-1.
Lab=c·tp (4)
where c is the speed of light.

After the distance calculating unit 33a calculates the distance, as shown in FIG. 8, the pulse determining unit 34-1 determines the amplitude and the repetition frequency of impulses according to the distance calculated by the distance calculating unit 33a based on the table 35-1 [see (l) in FIG. 8].

Here, the pulse determining unit 34-1 determines the power attenuation amount of the ATT 25a as the amplitude of impulses based on the table 35-1, and also determines the 1-chip time due to the pulse frequency source 20a from the maximum PRF as the repetition frequency of impulses.

Subsequently, the communication apparatus 10a-1 transmits the determined amplitude and the repetition frequency of impulses to the communication apparatus 10b-1 as transmission data [see (m) of FIG. 8]. The pulse controlling unit 36a-1 controls the ATT 25a and the pulse frequency source 20a, thereby setting the amplitude and the repetition frequency of the impulses [see (n) of FIG. 8].

When the communication apparatus 10b-1 receives the amplitude and the repetition frequency of impulses from the communication apparatus 10a-1, the pulse controlling unit 36b-1 controls the ATT 25b and the pulse frequency source 20b, thereby setting the amplitude and the repetition frequency of the received impulses (see (o) of FIG. 8). The initial setting is thus completed.

The communication apparatus 10a-1 and the communication apparatus 10b-1 then transceive data therebetween using impulses with the amplitude and the repetition frequency having been set at the initial setting [see (p) and (q) of FIG. 8].

After that, upon completion of transceiving data, the pulse controlling units 36a-1 and 36b-1 of the communication apparatuses 10a-1 and 10b-1, respectively, set the amplitude of impulses to the maximum value and also set the repetition frequency to the minimum value, in preparation for initial setting for transceiving processing of the next data [see (r) and (s) of FIG. 8].

In this manner, according to the radio communication system 1 (communication apparatuses 10a-1 and 10b-1) of the first embodiment of the present invention, the impulse adjusting unit 15-1 adjusts the amplitude and the repetition frequency of impulses used in radio communication in accordance with the distance between the communication apparatuses 10a-1 and 10b-1 detected by the distance detecting unit 10d. Thus, in cases where the distance between the communication apparatuses 10a-1 and 10b-1 is large, even when the amplitude of impulses is increased because the reception scheme is a non-coherent scheme, the repetition frequency can also be adjusted, so that long distance communication is reliably realized while strictly observing the reference values such as the FCC mask.

In cases where the distance between the communication apparatuses 10a-1 and 10b-1 is short, the impulse adjusting unit 15-1 reduces the amplitude of impulses while increasing the repetition frequency of impulses, thereby realizing high-speed communication.

In this instance, the pulse determining unit 34-1 of the impulse adjusting unit 15-1 determines the amplitude and the repetition frequency of impulses used in communication based on the contents of the table 35-1. By setting the table 35-1 with consideration paid to the reference values of the peak radiation power and the average radiation power, the impulse adjusting unit 15-1 is capable of adjusting the amplitude of impulses so that the peak radiation power becomes equal to or smaller than a specified value, and is also capable of setting the repetition frequency of impulses so that the average radiation power becomes equal to or smaller than a specified value.

Further, since the distance calculating unit 33a of the distance detecting unit 14 detects the distance between the communication apparatuses 10a-1 and 10b-1 based on a propagation time which is required for impulses to travel therebetween, it is possible to reliably calculate the distance between the communication apparatuses 10a-1 and 10b-1 even if the timer 30a of the communication apparatus 10a-1 is not completely synchronized with the timer 30b of the communication apparatus 10b-1.

Furthermore, in the radio communication system 1, at the initial setting time, since the distance detecting unit 14 uses impulses with the maximum amplitude and the minimum repetition frequency as impulses for detecting the distance between the communication apparatuses 10a-1 and 10b-1. Thus, even when the distance therebetween is the maximum distance the radio communication system 1 can support, it is still possible to reliably execute the initial setting, thereby setting the amplitude and the repetition frequency appropriately.

### [2] Second Embodiment

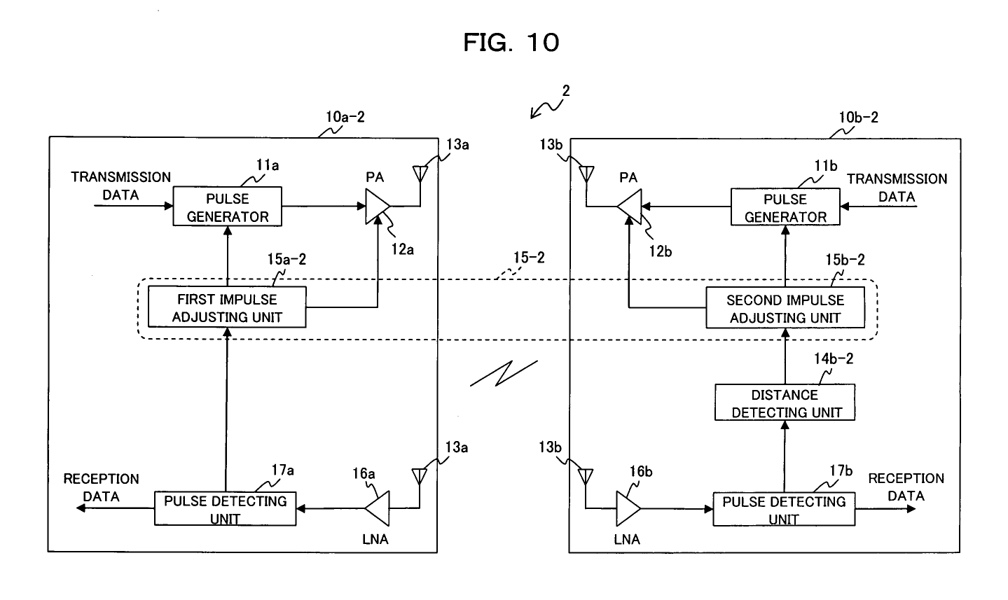

Next, referring to the block diagram of FIG. 10, a description will be made hereinbelow of a construction of a radio communication system according to a second embodiment of the present invention. In FIG. 10, like reference characters designate elements the same as or similar to elements already described, so their detailed description is omitted here.

As shown in FIG. 10, the present radio communication system 2 includes multiple (here, two) communication apparatuses (10a-2 and 10b-2). The system construction is similar to that of the radio communication system 1 of the above-described first embodiment except for the distance detecting unit 14b-2 and the impulse adjusting unit 15-2. In this instance, in the radio communication system 1 of the first embodiment already described, the distance detecting unit 14 includes the first distance detecting unit 14a of the communication apparatus 10a-1 and the second distance detecting unit 14b-1 of the communication apparatus 10b-1. However, in the radio communication system 2, a distance detecting unit 14b-2 is provided for a communication apparatus 10b-2.

Further, in the radio communication system 2, the impulse adjusting unit 15-2 includes a first impulse adjusting unit 15a-2 of the communication apparatus 10a-2 and a second impulse adjusting unit 15b-2 of the communication apparatus 10b-2.

Hereafter, a description will be made in detail of the distance detecting unit 14b-2 and the impulse adjusting unit 15-2.

That is, the distance detecting unit 14b-2 of the radio communication system 2 measures the distance between the communication apparatuses 10a-2 and 10b-2 by the RSS (Receive Single Strength) scheme. More specifically, on the basis of the electric power which is sent from one (communication apparatus 10a-2) of the two communication apparatuses and is then received by the other one (communication apparatus 10b-2), the distance between the communication apparatuses 10a-2 and 10b-2 is detected.

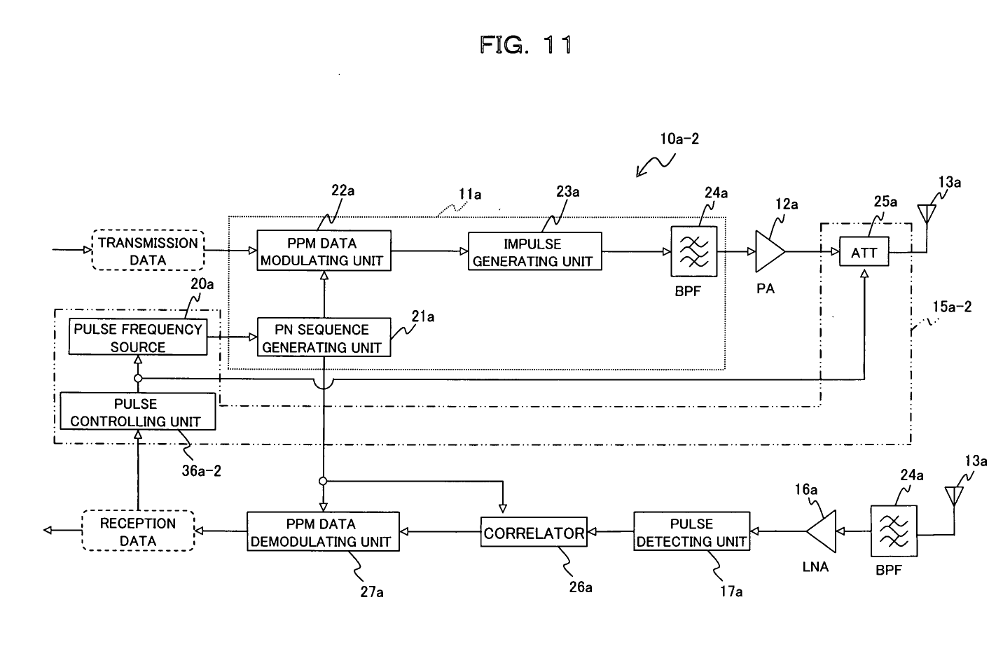

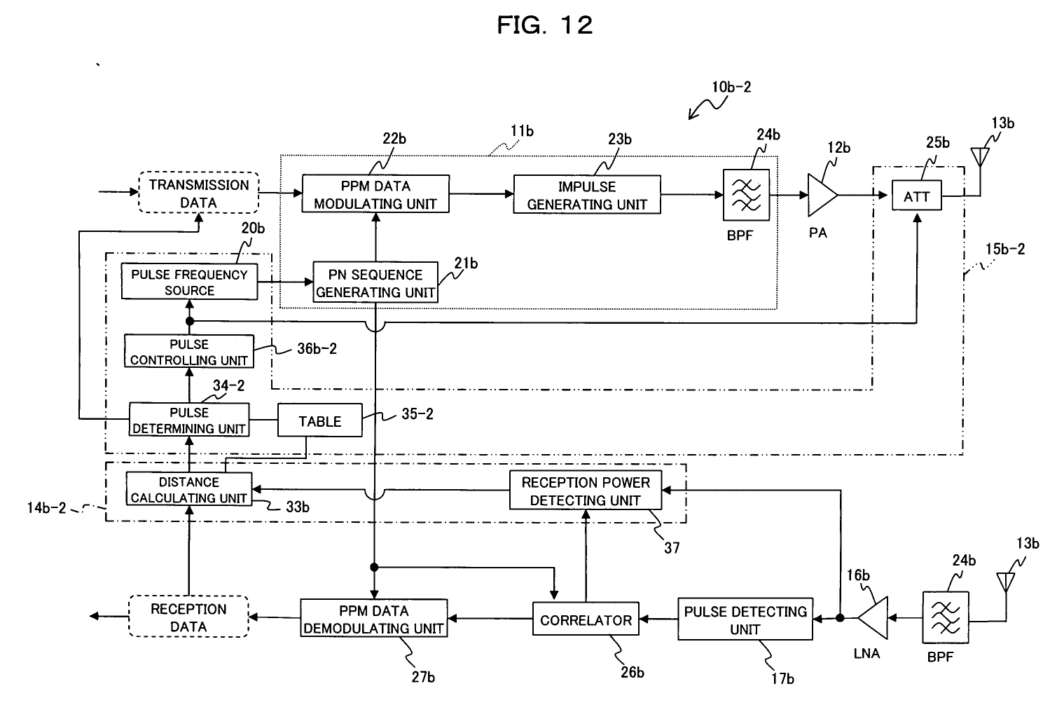

Here, referring to the block diagram of FIG. 11, a description will be made hereinbelow of a construction of the communication apparatus 10a-2 of the radio communication system 2. In addition, referring to the block diagram of FIG. 12, a description will be made hereinbelow of a construction of the communication apparatus 10b-2 of the radio communication system 2. In FIG. 11 and FIG. 12, like reference characters designate elements the same as or the similar to those already described, so their detailed description will be omitted here.

As shown in FIG. 11, the communication apparatus 10a-2 includes: a PA 12a; an antenna 13a; an LNA 16a; a pulse detecting unit 17a; a pulse frequency source 20a; a PN sequence generating unit 21a; a PPM data modulating unit 22a; an impulse generating unit 23a; a BPF 24a; an ATT 25a; a correlator 26a; a PPM data modulating unit 27a; and a pulse controlling unit 36a-2.

To transmit impulses with the amplitude and the frequency used in radio communication, which are received from the communication apparatus 10b-2, the pulse controlling unit 36a-2 controls the pulse frequency source 20a and the ATT 25a. Here, the pulse controlling unit 36a-2, and the pulse frequency source 20a, the ATT 25a, function as a first impulse adjusting unit 15a-2.

As shown in FIG. 12, the communication apparatus 10b-2 includes a PA 12b; an antenna 13b; an LNA 16b; a pulse detecting unit 17b; a pulse frequency source 20b; a PN sequence generator 21b; a PPM data modulating unit 22b; an impulse generating unit 23b; a BPF 24; an ATT 25b; a correlator 26b; a PPM data demodulating unit 27b; a reception power detecting unit (power detecting unit) 37; a distance calculating unit 33b; a table 35-2; a pulse determining unit 34-2; and a pulse controlling unit 36b-2.

The reception power detecting unit 37 detects impulses (here, a distance measurement command) transmitted from the communication apparatus 10a-2, and detects the reception power when the preamble portion of data is received from the communication apparatus 10a-2 by the correlator 26b.

Here, the reception power detecting unit 37 detects the power of impulses after the impulses passes through the LNA 16b as a reception power.

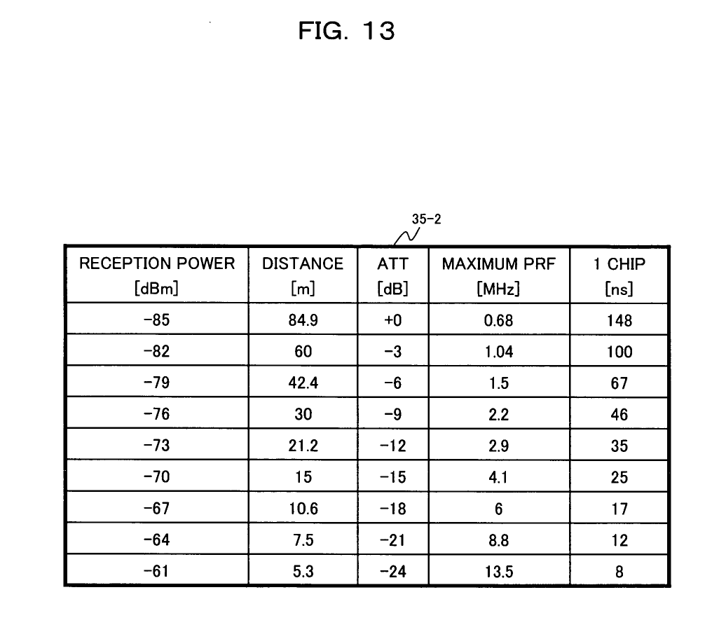

Then, the distance calculating unit 33b detects the distance between the communication apparatuses 10a-2 and 10b-2 according to the power detected by the reception detecting unit 37, based on the table 35-2 constructed as shown in FIG. 13. Here, as shown in FIG. 13, the table 35-2 holds 9-stage distances (“84.9 m”, “60 m”, “42.4 m”, “30 m”, “21.2 m”, “15 m”, “10.6 m”, “7.5 m”, and “5.3 m”) corresponding to 9-stage reception power (“−85 dBm”, “−82 dBm”, “−79 dBm”, “−76 dBm”, “−73 dBm”, “−70 dBm”, “−67 dBm”, “−64 dBm”, and “−61 dBm”), respectively.

Further, as in the case of the above-described pulse determining unit 34-1, the table 35-2 holds the power attenuation amount of the ATT 25a corresponding to each distance, the maximum PRF, and 1-chip time.

Here, the reception power detected by the reception power detecting unit 37 is greater than −61 dBm, the distance calculating unit 33b decides that the distance between the communication apparatuses 10a-2 and 10b-2 is shorter than 5.3 m, based on the table 35-2.

When the distance calculating unit 33b detects the distance between the communication apparatus 10a-2 and communication apparatus 10b-2 is shorter than 5.3 m, the pulse determining unit 34-2 determines the amplitude and the repetition frequency of impulses based on the table 35-2. In this case, the pulse determining unit 34-2 sets the power attenuation amount of the ATT 25b, as the amplitude of impulses, to −24 dB, and sets the 1-chip time due to the pulse frequency source 20b to 8ns, regarding the maximum PRF as the repetition frequency of impulses to be 13.5 MHz.

When the power detected by the reception power detecting unit 37 is lower than −61 dBm inclusive and also larger than 64 dBm inclusive, the distance calculating unit 33b determines that the distance is 7.5 m, based on table 35-2. The pulse determining unit 34-2 then determines the amplitude (the ATT 25b is −21 dB) and the repetition frequency of impulses (the maximum PRF is 8.8 MHz; 1-chip time of the pulse frequency source 20b is 12 ns) corresponding to a distance of 7.5 m.

In this manner, in the communication apparatus 10b-2, the reception power detecting unit 37 and the distance calculating unit 33b function as a distance detecting unit 14b-2. The pulse determining unit 34-2, the pulse controlling unit 36b-2, the pulse frequency source 20b, the ATT 25b function as a second impulse adjusting unit 15b-2.

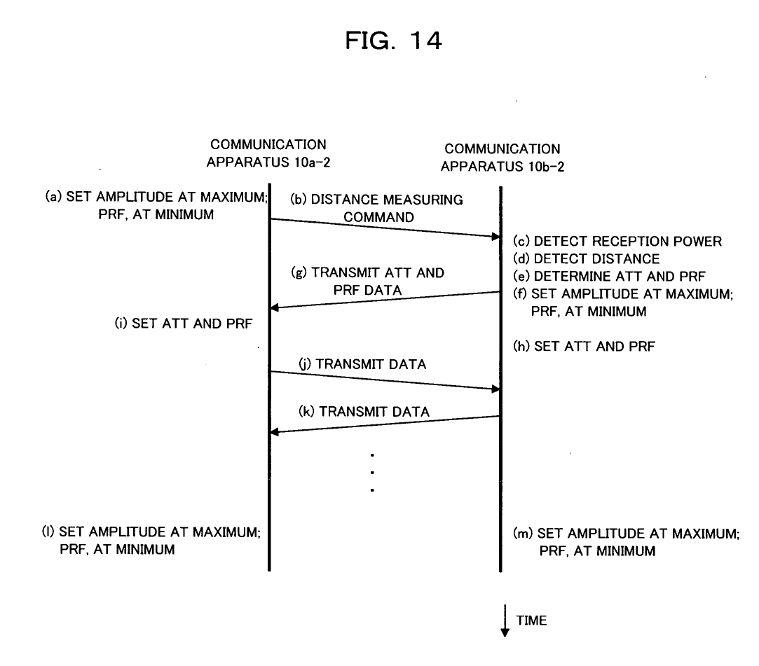

Next, referring to FIG. 14, a description will be made hereinbelow of the procedures (that is, communication procedures between the communication apparatuses 10a-2 and 10b-2) of processing carried out by the present radio communication system 2.

First of all, the communication apparatus 10a-2 sets the amplitude of impulses used at the initial setting time, to the maximum value, and the repetition frequency of impulses to the minimum value [see (a) in FIG. 14].

Subsequently, the communication apparatus 10a-2 uses impulses with the maximum amplitude and the minimum repetition frequency to transmit a distance measurement command for measuring the distance between the communication apparatuses 10a-2 and 10b-2, between which communication is to be performed, to the communication apparatus 10b-2 [see (b) of FIG. 14].

When the communication apparatus 10b-2 receives this distance measurement command, the reception power detecting unit 37 detects the power of impulses that have been received [see (c) of FIG. 14]. (Concretely, the reception power detecting unit 37 detects the reception power when the preamble portion of the distance measuring command is detected by the correlator 26b).

Then, the distance calculating unit 33b detects the distance corresponding to the reception power detected by the reception power detecting unit 37 [see (d) of FIG. 14]. On the basis of the table 35-2, the pulse determining unit 34-2 determines the power attenuation amount of the ATT 25b as the amplitude of impulses corresponding to the distance detected by the distance calculating unit 33b and the 1-chip time due to the pulse frequency source 20b as the repetition frequency of impulses [see (e) of FIG. 14].

After that, as in the case of the communication apparatus 10a-2, the communication apparatus 10b-2 sets the amplitude of impulses to the maximum value, and also sets the repetition frequency of impulses to the minimum value [see (f) of FIG. 14], and sends the power attenuation amount of the ATT 25a and the 1-chip time of the pulse frequency source 20b to the communication apparatus 10a-2 [see (g) of FIG. 14].

In this instance, in the communication apparatus 10b-2, the pulse controlling unit 36b-2 controls the ATT 25b and the pulse frequency source 20b to perform setting of the amplitude and the repetition frequency determined by the pulse determining unit 34-2 [see (h) of FIG. 14].

When the communication apparatus 10a-2 receives the amplitude and the repetition frequency of impulses from the communication apparatus 10b-2, the pulse controlling unit 36a-2 controls the ATT 25a and pulse frequency source 20a to perform setting of the amplitude and the repetition frequency [see (i) of FIG. 14], thereby completing initial setting.

After that, the communication apparatuses 10a-2 and 10b-2 use the amplitude and the repetition frequency of impulses, which have been set at initial setting, to transceive data therebetween [see (j) and (k) of FIG. 14].

Upon completion of data transceiving, the pulse controlling units 35 and 35b-2 of the communication apparatuses 10a-2 and 10b-2, respectively, set the amplitude of impulses to the maximum value in order to restore the initial setting value of impulses, and also sets the repetition frequency of impulses to the minimum value [see (l) and (m) of FIG. 14].

In this manner, according to the radio communication system 2 of the second embodiment of the present invention, the above described effects are obtained. In addition, although the reception power detected by the reception power detecting unit 37 cannot sometimes be correctly measured because of circumstances such as multipath or blocking, the pulse determining unit 34-2 sets the amplitude and the repetition frequency of impulses including such circumstances. Thus, it is possible to set the amplitude and the repetition frequency in conformity with such circumstances. As a result, communication between the communication apparatus 10a-2 and the communication apparatus 10b-2 can be reliably realized.

Further, according to the radio communication system 2, when the communication apparatus 10b-2 receives impulses as a distance measurement command sent from the communication apparatus 10a-2, the communication apparatus 10b-2 determines the amplitude and the repetition frequency of impulses to be used in radio communication based on the reception power of the impulses. Thus, the processing procedures required at the initial setting are reduced in comparison with those in the above-described first embodiment, so that the time required for performing the initial setting is decreased.

### [3] Third Embodiment:

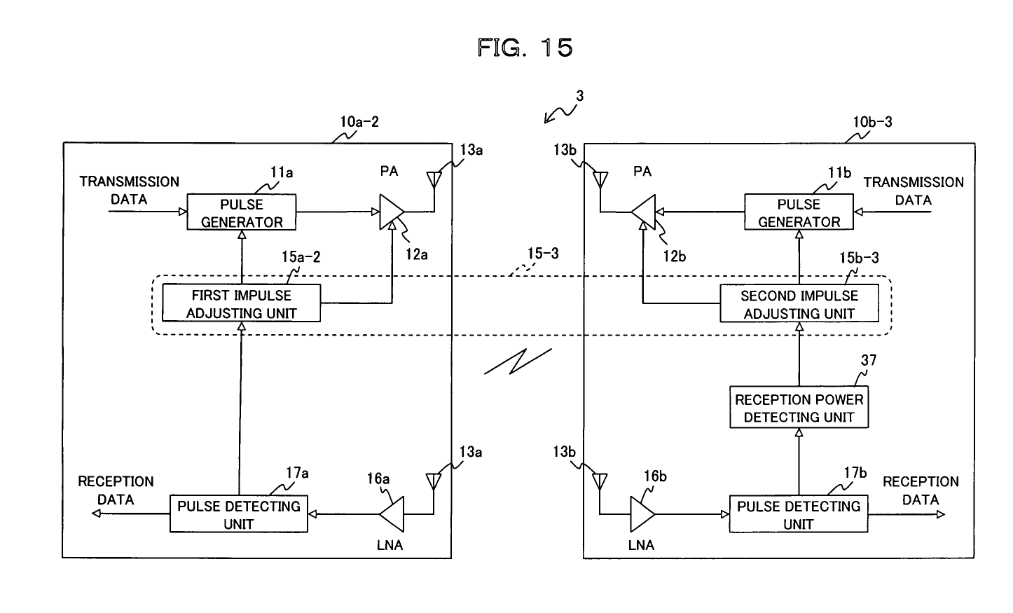

Next, a description will be made hereinbelow of a radio communication system according to a third embodiment of the present invention. As shown in FIG. 15, the present radio communication system 3 includes communication apparatuses 10a-2 and 10b-3, and its construction is similar to that of the second embodiment except for a reception detecting unit (power detecting unit) 37 and an impulse adjusting unit 15-3. In FIG. 15, like reference characters designate elements the same as or similar to elements already described, so their detailed description is omitted here.

That is, in the radio communication system 2 of the second embodiment, the distance detecting unit 14b-2 detects the distance between the communication apparatuses 10a-2 and 10b-2. On the basis of the detected distance, the impulse adjusting unit 15-2 determines the amplitude and the repetition frequency of impulses. According to the third embodiment, however, the communication apparatus 10b-3 does not detect the distance between the communication apparatuses 10a-2 and 10b-3, and the impulse adjusting unit 15-3 directly determines the amplitude and the repetition frequency of impulses used in radio communication between the communication apparatuses 10a-2 and 10b-3 according to the power detected by the reception power detecting unit (power detecting unit) 37 and performs controlling (adjustment).

In this instance, the impulse adjusting unit 15-3 includes a first impulse adjusting unit 15a-2 and a second impulse adjusting unit 15b-3 of the communication apparatus 10a-2 and the first impulse adjusting unit 15a-2, respectively.

Further, in the radio communication system 3, the communication apparatus 10a-2 has a construction similar to that of the communication apparatus 10a-2 of the second embodiment as shown in FIG. 11, and thus, its detailed description is omitted here.

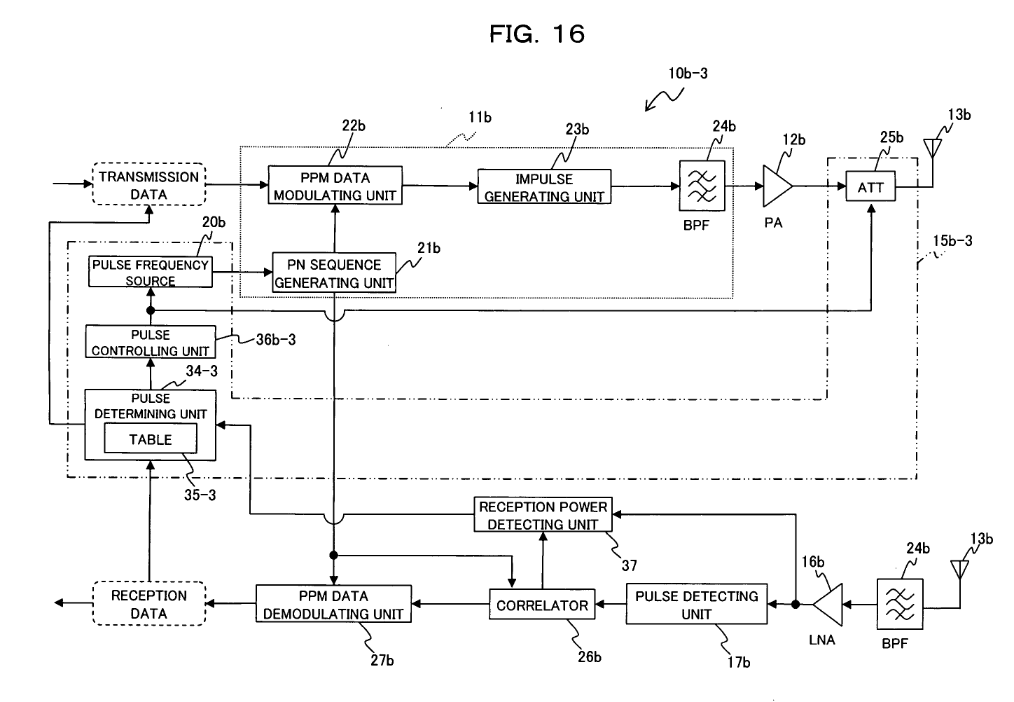

Now, referring to the block diagram of FIG. 16, a description will be made hereinbelow of a construction of the communication apparatus 10b-3. As shown in FIG. 16, the communication apparatus 10b-3 detects the power of impulses as the reception power when the preamble portion of data received from communication apparatus 10a-2 is detected by the correlator 26b.

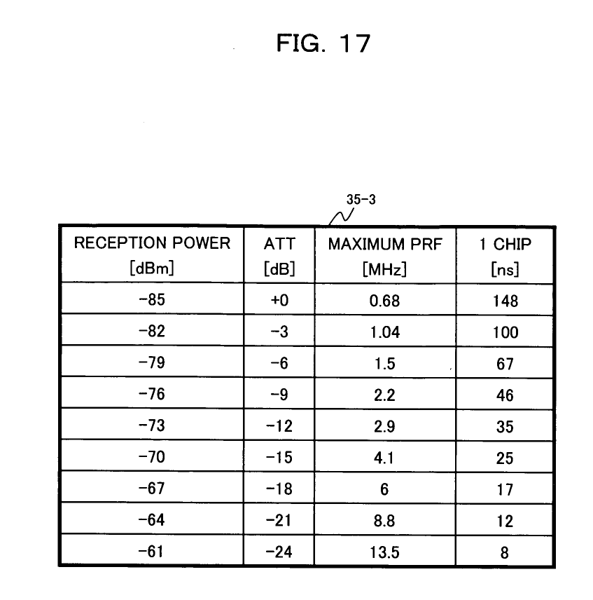

Then, a pulse determining unit 34-3 determines the amplitude and the repetition frequency of impulses according to the reception power detected by the reception power detecting unit 37 based on a table 35-3 constructed as shown in FIG. 17.

Here, the table 35-3 of FIG. 17 does not have an item of distance in comparison with the table 35-2 held by the communication apparatus 10b-2 of the second embodiment as shown in FIG. 13. Except for this point, the table 35-3 has a construction similar to that of the table 35-2. Hence, the table 35-3 is used in a way similar to the above-described table 35-2.

Further, in the communication apparatus 10b-3, a pulse controlling unit 36b-3 controls the pulse frequency source 20b and the ATT 25b in such a manner that the amplitude and the repetition frequency of impulses output from the communication apparatus 10a-2 become those that are determined by the table 35-3 is obtained.

In this manner, in the communication apparatus 10b-3, the pulse frequency source 20b, the ATT 25b, the pulse determining unit 34-3, and the pulse controlling unit 36b-3 function as a second impulse adjusting unit 15b-3.

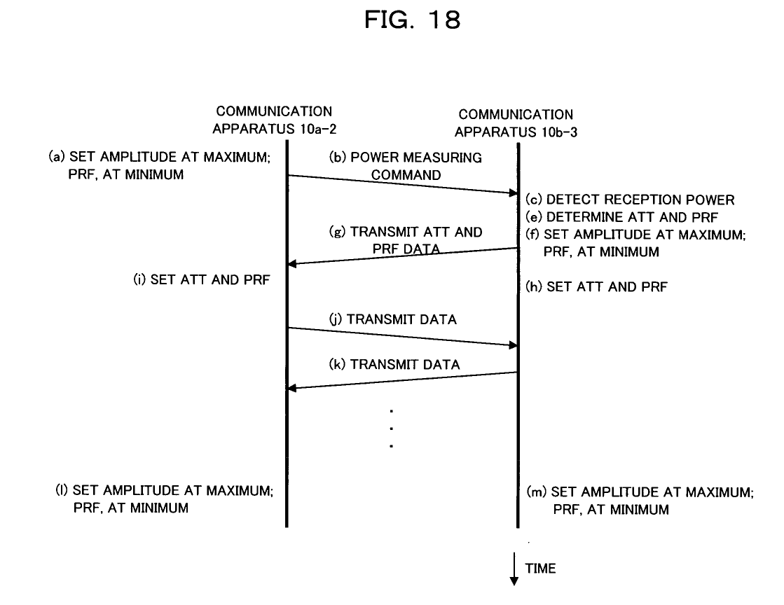

Accordingly, as shown in FIG. 18, the processing procedures (that is, the communication procedures between the communication apparatus 10a-2 and the communication apparatus 10b-3) performed by the radio communication system 3 does not include the procedure of detecting the distance between the communication apparatus 10a-2 and the communication apparatus 10b-2 as shown in FIG. 14 [see (d) of FIG. 14]. When the reception power detecting unit 37 detects the power of impulses as a power measurement command from the communication apparatus 10a-2 [see (c) of FIG. 18], the pulse determining unit 34-3 directly determines the amplitude and the repetition frequency of impulses according to the detected power of impulses based on the table 35-3 [see (e) of FIG. 18].

In this manner, according to the radio communication system 3 of the third embodiment of the present invention, like effects and benefits to those of the second embodiment will be realized, and also, the efficiency of an initial operation is improved because the process of detecting the distance between the communication apparatuses 10a-2 and 10b-3 is omitted in comparison with the above-described second embodiment.

### [4] Fourth Embodiment

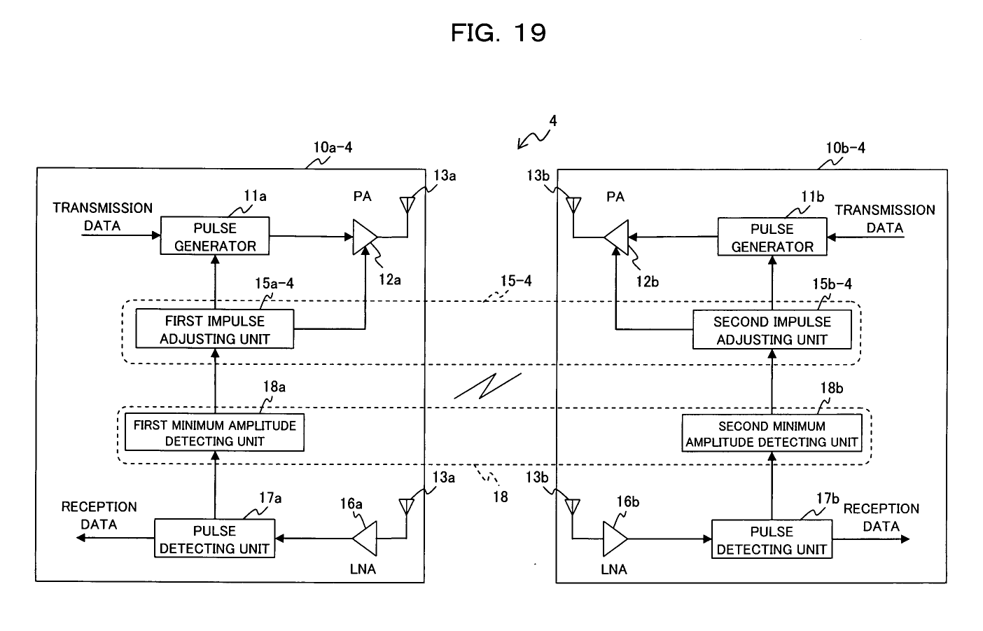

Next, a description will be made of a radio communication system of the fourth embodiment of the present invention. As shown in FIG. 19, the present radio communication system 4 includes communication apparatuses 10a-4 and 10b-4, and its construction is similar to that of the radio communication system 1 of the first embodiment except for an impulse adjusting unit 15-4 and a minimum amplitude detecting unit 18. In FIG. 19, like reference characters designate elements the same as or similar to elements already described, so their detailed description is omitted here.

Now, a detailed description will be made hereinbelow of the minimum amplitude detecting unit 18 and the impulse adjusting unit 15-4.

The minimum amplitude detecting unit 18 includes a first minimum amplitude detecting unit 18a of the communication apparatus 10a-4 and a second minimum amplitude detecting unit 18b. The minimum amplitude detecting unit 18 detects the minimum amplitude of impulses sent from one (here, the communication apparatus 10a-4) of the communication apparatuses 10a-4 and 10b-4 which can be received by the other one (here, the communication apparatus 10b-4) of the communication apparatuses 10a-4 and 10b-4.

More specifically, the minimum amplitude detecting unit 18 attenuates the amplitude level (radio wave intensity) of impulses sent from the communication apparatus 10a-4 in stages, and detects the amplitude of an impulse which has been sent from the communication apparatus 10a-4 immediately before the communication apparatus 10b-4 becomes unable to correctly receive the impulses, as the minimum amplitude.

The impulse adjusting unit 15-4 includes a first impulse adjusting unit 15a-4 of the communication apparatus 10a-4 and a second impulse adjusting unit 15b-4 of the communication apparatus 10b-4. In accordance with the minimum amplitude of impulses detected by the minimum amplitude detecting unit 18, the impulse adjusting unit 15-4 adjusts the amplitude and the repetition frequency of impulses used in radio communication between the communication apparatuses 10a-4 and 10b-4.

More concretely, the impulse adjusting unit 15-4 sets the amplitude of impulses used in communication to a value greater than the minimum amplitude detected by the minimum amplitude detecting unit (an amplitude greater by one stage than the amplitude detected as the minimum amplitude, when the minimum amplitude detecting unit 18 attenuates the amplitude level in stages), and also sets the repetition frequency corresponding to the amplitude having been set).

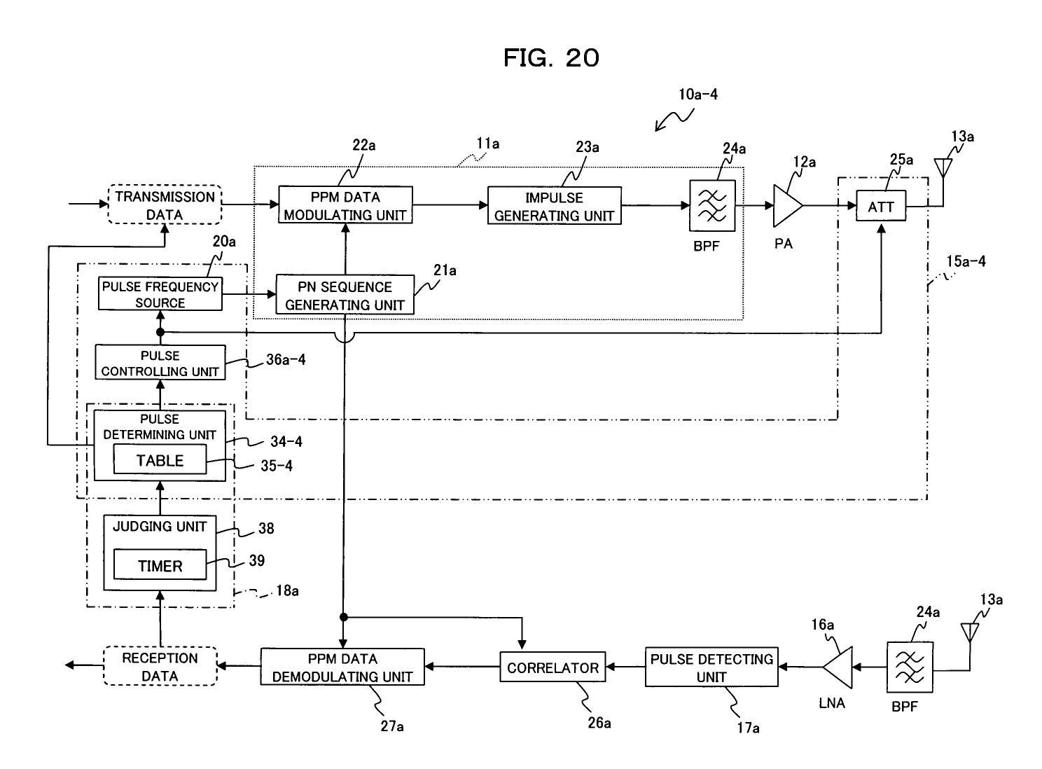

Here, referring to FIG. 20, a description will be made hereinbelow of a construction of communication apparatus 10a-4 of the present radio communication system 4. In this instance, in FIG. 20, like reference characters designate elements the same as or similar to elements already described, so their detailed description is omitted here.

As shown in FIG. 20, the communication apparatus 10a-4 includes: a PA 12a; an antenna 13a; an LNA 16a, a pulse detecting unit 17a; a pulse frequency source 20a; a PN sequence generating unit 21a; a PPM data modulating unit 22a; an impulse generating unit 23a; a BPF 24a; an ATT 25a; a correlator 26a; a PPM data modulating unit 27a; a judging unit 38; a pulse determining unit 34-4; and a pulse controlling unit 36a-4.

The judging unit 38 evaluates whether or not the communication apparatuses 10b-4-correctly receives a reception confirmation command for confirming correct reception of a reception confirmation command sent from the communication apparatus 10a-4 at the initial setting time, and has a timer 39.

The timer 39 detects an elapse of a specified time after the transmission of a reception confirmation command by the communication apparatus 10a-4.

Now, a description will be made hereinbelow of a decision-making method of the judging unit 38. After sending out a reception confirmation command to the communication apparatuses 10b-4, if the judging unit 38 receives a reception confirmation command (success response) indicating a successful reception of the reception confirmation command from the communication apparatus 10b-4 before the timer 39 detects the elapse of a specific time, the judging unit 38 decides that the communication apparatus 10b-4 has correctly received the reception confirmation command. In this instance, when receiving a successful response from the communication apparatus 10b-4, the judging unit 38 resets the timer 39.

On the other hand, after transmission of a reception confirmation command, if the timer 39 detects an elapse of a specified time (that is, if a reception confirmation command is not received from the communication apparatus 10b-4 within a specified time period after transmission of a reception confirmation command), it is decided that the communication apparatus 10b-4 has not been correctly received.

Since the judging unit 38 makes a judgment in this manner, the specified time period measured by the timer 39 is set to a sufficiently long time, with consideration paid to the time period required for the communication apparatus 10b-4 to generate a successful response after the communication apparatus 10b-4 receives a reception confirmation command and to the time required for the successful response to arrive at the communication apparatus 10a-4.

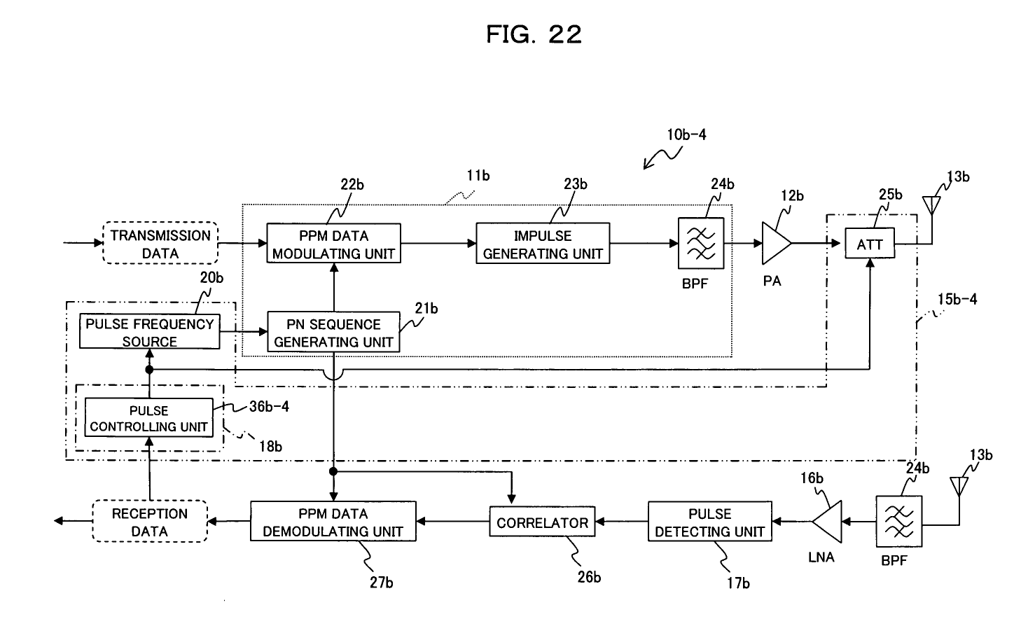

Here, cases where the communication apparatus 10b-4 is not capable of receiving a reception confirmation command correctly mean a case where the communication apparatus 10b-4 can only receive a part of a reception confirmation command, or a case where an error rate becomes greater than a predetermined specific value, or a case where a reception confirmation command is not received at all and the correlator 26b (see FIG. 22) cannot perform synchronization.

While the judging unit 38 keeps deciding that a reception confirmation command has been correctly received by the communication apparatus 10b-4, the pulse determining unit 34-4 determines the amplitude level of impulses as a reception confirmation command so that the amplitude level is attenuated in stages every time such a judgment is made.

That is, when the judging unit 38 decides that the communication apparatuses 10b-4 has correctly received a reception confirmation command, the pulse determining unit 34-4 sets the amplitude level lower than the amplitude level of impulses as a reception confirmation command as an amplitude level of the reception confirmation command which is to be subsequently transmitted.

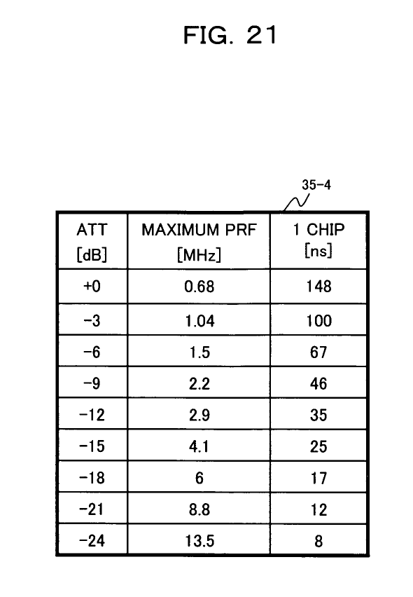

More specifically, the pulse determining unit 34-4 has a table 35-4 as shown in FIG. 21. The pulse determining unit 34-4 sets impulses, as an initial reception confirmation command at the initial setting time, to the maximum amplitude (that is, the power attenuation amount of the ATT 25a is “0 dB”) and to the minimum repetition frequency (that is, the maximum PRF is “0.68 MHz”). After that, every time the judging unit 38 decides that a reception confirmation command has been correctly received, the pulse determining unit 34-4 attenuates the amplitude level of impulses as a reception response command to be subsequently transmitted in stages (here, the power attenuation amount of the ATT 25a is attenuated by −3 dB) based on the table 35-4.

When the judging unit 38 decides that the communication apparatuses 10b-4 has not received a reception confirmation command correctly, the pulse-determining unit 34-4 detects the minimum amplitude which can be correctly received by the communication apparatus 10b-4 as the amplitude level (here, the amplitude level larger than the reception confirmation command by one stage) of the reception confirmation command transmitted to the communication apparatus 10b-4 immediately before the reception confirmation command.

That is, in this example, the pulse determining unit 34-4 detects any one of the nine stages of setting values of the ATT 25a as the minimum amplitude of impulses.

Further, the pulse determining unit 34-4 determines the detected minimum amplitude or an amplitude further greater than the minimum amplitude level (for example, the amplitude level greater than the minimum amplitude level by one or more stages) as the amplitude of impulses used in radio communication.

For example, when the detected minimum amplitude of the ATT 25a is a power attenuation amount of “−12 dB”, the pulse determining unit 34-4 determines the amplitude of impulses used in radio communication as a power attenuation amount of the ATT 25a of “−12 dB”, “−9 dB”, “−6 dB”, or “−3 dB”. In this manner, by setting the amplitude of impulses to a value greater than the minimum amplitude (giving a margin), communication between the communication apparatuses 10a-4 and 10b-4 is reliably performed.

Then, on the basis of the table 35-4, the pulse determining unit 34-4 determines the repetition frequency (here, the 1-chip time due to the pulse frequency source 20a corresponding to the maximum PRF) of impulses corresponding to the determined amplitude (here, the power attenuation amount of the ATT 25a).

The pulse controlling unit 36a-4 controls the pulse frequency source 20a and the ATT 25a based on the power attenuation amount of the ATT 25a and the maximum PRF (1-chip time) determined by the pulse determining unit 34-4.

The pulse controlling unit 36a-4 controls impulses as a reception confirmation command at the amplitude level determined by the pulse determining unit 34-4 at the initial setting.

In this manner, in the communication apparatus 10a-4, the judging unit 38, the pulse determining unit 34-4, the pulse controlling unit 36a-4, the pulse frequency source 20a, and ATT 25a, function as a first minimum amplitude detecting unit 18a. Further, the pulse determining unit 34-4, the pulse controlling unit 36a-4, the pulse frequency source 20a, and the ATT 25a also function as a first impulse impulse-adjusting unit 15a-4.

Next, referring to FIG. 22, a description will be made hereinbelow of a construction of a communication apparatus 10b-4 in the present communication system 4. In FIG. 22, like reference characters designate elements the same as or similar to elements already described, so their detailed description is omitted here.

As shown in FIG. 22, the communication apparatus 10b-4 includes: a PA 12b; an antenna 13b; an LNA 16b; a pulse detecting unit 17b; a pulse frequency source 20b; a PN sequence generator 21b; a PPM data modulating unit 22b; an impulse generating unit 23b; a BPF 24b; an ATT 25b; a correlator 26b; a PPM data demodulating unit 27b; and a pulse controlling unit 36b-4.

The pulse controlling unit 36b-4 controls the pulse frequency source 20b and the ATT 25b based on the amplitude and the repetition frequency of impulses determined by the pulse determining unit 34-4 of the communication apparatus 10a-4, which impulses have been received from the communication apparatus 10a-4 as reception data.

Accordingly, in the communication apparatus 10b-4, the pulse controlling unit 36b-4 functions as a second minimum amplitude detecting unit 18b, and the pulse controlling unit 36b-4, the pulse frequency source 20b, and the ATT 25b function as a second impulse adjusting unit 15b-4.

In this instance, when receiving a reception confirmation command from the communication apparatus 10b-4 at the initial setting time, the communication apparatus 10b-4 transmits a reception confirmation command response to the communication apparatus 10a-4 in response to the reception confirmation command.

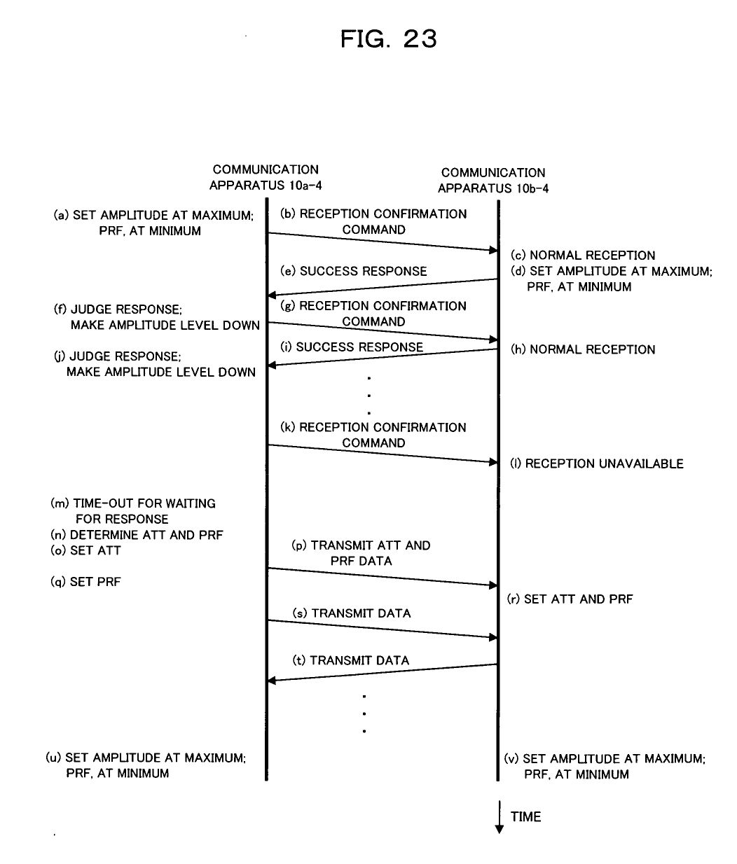

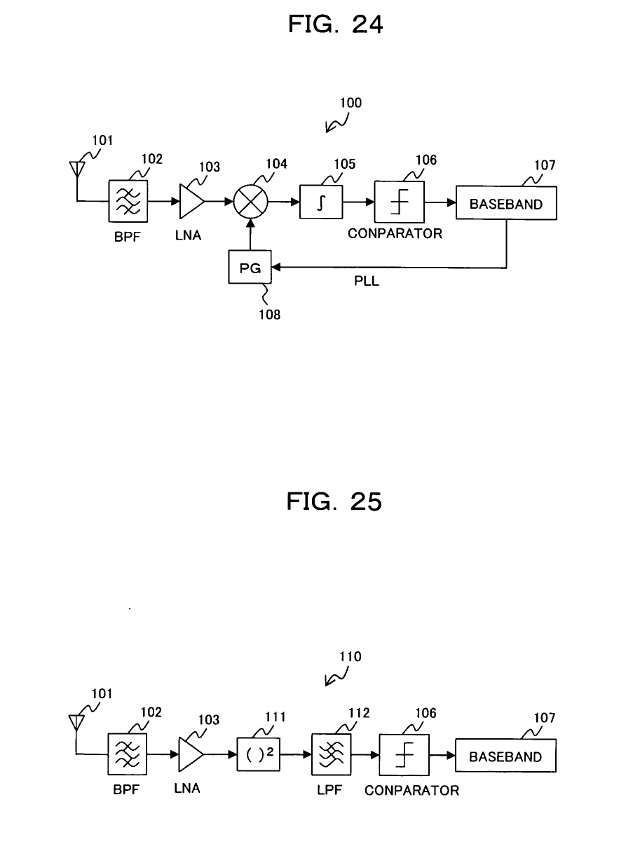

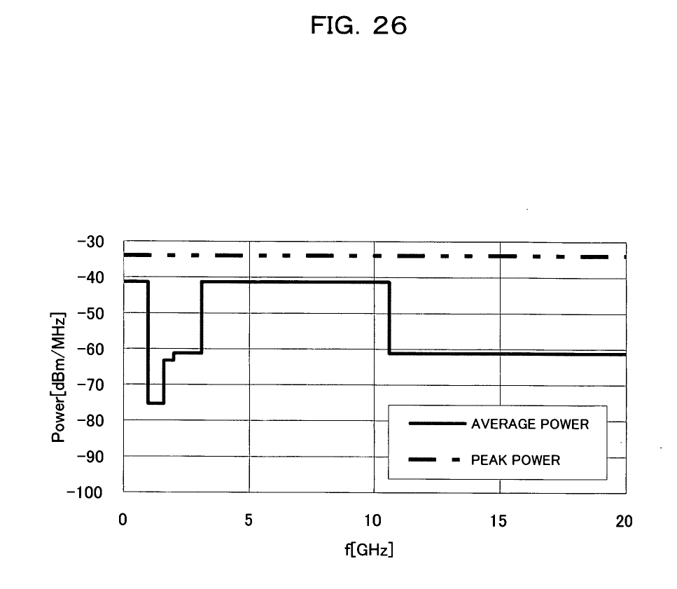

Next, referring to FIG. 23, a description will be made hereinbelow of the processing procedures (that is, communication procedures between the communication apparatuses 10a-4 and 10b-4) of the present radio communication system 4.

First of all, the pulse controlling unit 36a-4 of the communication apparatus 10a-4 sets the amplitude of impulses used in the initial setting to the maximum value, and also sets the repetition frequency of the impulses to the minimum value [see (a) of FIG. 23].

Subsequently, the communication apparatus 10a-4 uses the maximum amplitude and the minimum repetition frequency of impulses to transmit a reception confirmation command for confirming the reception to the communication apparatus 10b-4 [see (b) of FIG. 23]. In this instance, the timer 39 of the judging unit 38 starts counting a specific time period elapsed.

When the communication apparatus 10b-4 is capable of normally receiving the reception confirmation command (impulses) sent from the communication apparatus 10a-4 because the reception confirmation command has a sufficient radio wave intensity (amplitude) (that is, the correlator 26b is capable of obtaining correlation) [see (c) of FIG. 23], the pulse controlling unit 36b-4 of the communication apparatus 10b-4 sets the amplitude of impulses to the maximum value (sets the ATT 25b to “+0 dB”), as in the case of the processing (a) of the communication apparatus 10a-4, and also controls the pulse frequency source 20b so that the repetition frequency of impulses to the minimum value (1-chip is equal to 148 ns) [see (d) of FIG. 23].

After that, the communication apparatus 10b-4 sends a successful response (reception confirmation command response) to the communication apparatus 10a-4 in response to the reception confirmation command [see (e) of FIG. 23].

If the communication apparatus 10a-4 receives a successful response from the communication apparatus 10b-4 before the timer 39 detects an elapse of a specified time period, the judging unit 38 decides that the communication apparatus 10b-4 has correctly received the successful response, and resets the timer 39. In addition, the pulse determining unit 34-4 attenuates the amplitude level of impulses (the power attenuation amount of the ATT 25a) by one stage based on the table 35-4 [amplitude level down; see (f) of FIG. 23]. In this instance, the repetition frequency of impulses maintains the level of the minimum repetition frequency having been set in the above-mentioned process (a), and the repetition frequency will not be changed during the initial setting.

Next, the communication apparatus 10a-4 transmits a reception confirmation command once again to the communication apparatus 10b-4 at the amplitude level of impulses having been set at the procedure (f) [see (g) of FIG. 23].

After that, the processing corresponding to the above processes (b), (c), (e), and (f), is repeated [see (h) (i), (j), and (k) of FIG. 23].

Here, if the amplitude level of impulses, as a reception confirmation command, from the communication apparatus 10a-4 is decreased too much to be correctly received by the communication apparatus 10b-4 [see (1) of FIG. 23], and the timer 39 of the judging unit 38 thus detects elapse of the specified time period after transmission of the reception confirmation command [when time-out for the reception confirmation command occurs; see (m) of FIG. 23], the judging unit 38 decides that the communication apparatus 10b-4 can not receive the reception confirmation command.

Then, when the pulse determining unit 34-4 detects the amplitude level of the reception confirmation command transmitted immediately before the reception of the confirmation command (here, any of the power attenuation amounts of the ATT 25a shown in the table 35-4), as the minimum amplitude, and also determines the power attenuation amount of the ATT 25a to be greater than the detected minimum amplitude by one stage as the amplitude level of impulses used in radio communication between the communication apparatus 10a-4 and the communication apparatus 10b-4.

Further, the pulse determining unit 34-4 determines the repetition frequency (1-chip unit time corresponding to the PRF) of impulses corresponding to the determined amplitude level (the power attenuation amount of the ATT 25a), based on the table 35-4 [see (n) of FIG. 23].

Then, the pulse controlling unit 36a-4 sets the power attenuation amount of the ATT 25a to the attenuation amount determined by the pulse determining unit 34-4 [see (o) of FIG. 23]. Further, the communication apparatus 10a-4 transmits the amplitude and the repetition frequency determined by the pulse determining unit 34-4 to the communication apparatus 10b-4 [see (p) of FIG. 23].

At this time, in the communication apparatus 10a-4, the pulse controlling unit 36a-4 controls the pulse frequency source 20a, thereby setting the repetition frequency (1-chip unit time) [see (q) of FIG. 23].

When the communication apparatus 10b-4 receives the amplitude and the repetition frequency of impulses from the communication apparatus 10a-4, the pulse controlling unit 36b-4 controls the ATT 25b and the pulse frequency source 20b, thereby setting the amplitude and the repetition frequency of the received impulses [see (r) of FIG. 23]. Then, the initial setting is completed.

Then, the communication apparatuses 10a-4 and 10b-4 transceive data with each other using the amplitude and the repetition frequency set at the initial setting [see (s) and (t) of FIG. 23].

After completion of transceiving of the data, the pulse controlling units 36a-4 and 36b-4 of the communication apparatuses 10a-4 and 10b-4, respectively, sets the amplitude of impulses to the maximum value in preparation for initial setting, and also sets the repetition frequency of impulses to the minimum value [see (u) and (v) of FIG. 23].

As described so far, in accordance with the radio communication system 4 of the fourth embodiment of the present invention, like effects to those of the above-described first embodiment are realized. In addition, it is possible to realize the radio communication system 4 with a construction which is more simple than that of the radio communication system 1 of the first embodiment and of the radio communication system 2 of the second embodiment.

Further, as in the case of the second embodiment, the amplitude and the repetition frequency of impulses eventually used is determined while the communication apparatus 10a-4 is transmitting impulses to the communication apparatus 10b-4, so that setting of the amplitude and the repetition frequency of impulses is available with consideration paid to multipath and blocking.

[5] Other Modifications:

Further, the present invention should by no means be limited to the above-illustrated embodiment, and various changes or modifications may be suggested without departing from the gist of the invention.

For example, in the above-describe embodiments, the two communication apparatuses differ from each other in construction. The present invention, however, should by no means be limited to this. In the first embodiment, for example, the above-described radio communication system 1 can have the communication apparatus 10a-1 and the communication apparatus 10b-1 with similar construction. Further, in the second embodiment, the radio communication system 2 can have the communication apparatus 10a-2 and the communication apparatus 10b-2 with a similar construction. Furthermore, in the third embodiment, the radio communication system 3 can have the communication apparatus 10a-2 and the communication apparatus 10b-3 with a similar construction. Moreover, in the fourth embodiment, the radio communication system 4 can have the communication apparatus 10a-4 and the communication apparatus 10b-4 with a similar construction.

Further, according to the first and the second embodiments, the impulse adjusting units 15-1 and 15-2 adjust the amplitude of impulses based on the tables 35-1 and 35-2. The present invention, however, should by no means be limited to this. For example, the impulse adjusting units 15-1 and 15-2 can adjust the amplitude of impulses to the reciprocal square root of the distance detected by the distance detecting units 14 and 14b-2. With this arrangement, like effects to those of the first and the second embodiment will be realized.

Further, in the above-described second embodiment, the distance calculating unit 33b and the pulse determining unit 34-2 of the communication apparatus 10b-2 commonly use the table 35-2. The present invention, however, should by no means be limited to this. For example, the table 35-2 can be divided so that the distance calculating unit 33b is constructed so as to execute processing based on the table indicating only the reception power and the distance, and that the pulse determining unit 34-2 is constructed so as to execute processing based on the table 35-1 of the first embodiment indicated in FIG. 5.

Further, in the above-described radio communication system 4, the description was made, taking an example in which the pulse determining unit 34-4, as the minimum amplitude detecting unit 18, attenuates the amplitude of the reception confirmation command in stages based on the table 35-4. The present invention, however, should by no means be limited to this in the method of changing the amplitude of impulses, as a reception confirmation command, at the initial setting time (that is, the minimum amplitude detection time) For example, the amplitude can be changed by two-divisional searching, thereby efficiently detecting the minimum amplitude.

What is claimed is:

1. A radio communication system including a plurality of communication apparatuses which are communicably connected with each other by radio under the UWB (Ultra WideBand)-impulse radio system, said radio communication system comprising:
a distance detecting unit which detects the distance between two communication apparatuses, of said plurality of communication apparatuses, said two communication apparatuses being to be communicably connected by radio; and
an impulse adjusting unit which adjusts the amplitude and the repetition frequency of impulses used in radio communication between the two communication apparatuses according to the distance detected by said distance detecting unit.

2. A radio communication system as set forth in claim 1, wherein said impulse adjusting unit (i) reduces the repetition frequency when increasing the amplitude of the impulses according to said distance, and (ii) increases the repetition frequency of the impulses when reducing the amplitude of the impulses according to said distance.

3. A radio communication system as set forth in claim 1, further comprising: a table which indicates the association among the distance between two communication apparatuses, the amplitude of the impulses, and the repetition frequency of the impulses,
said impulse adjusting unit adjusting the amplitude and the repetition frequency of the impulses based on the contents of said table.

4. A radio communication system as set forth in claim 1, wherein said impulse adjusting unit adjusts the amplitude of the impulses to a value which is inversely proportional to the square root of the distance detected by said distance detecting unit.

5. A radio communication system as set forth in claim 1, wherein said impulse adjusting unit adjusts the amplitude of the impulses so that a peak radiation power takes a value equal to or smaller than a specific value.

6. A radio communication system as set forth in claim 1, wherein said impulse adjusting unit adjusts the repetition frequency of the impulses so that an average radiation power takes a value equal to or smaller than a specific value.

7. A radio communication system as set forth in claim 1, wherein said distance detecting unit detects said distance based on a propagation time which is required for the impulses to travel between the two communication apparatuses.

8. A radio communication system as set forth in claim 1, wherein said distance detecting unit detects said distance based on electric power which is sent from one of the two communication apparatuses and is received by the other of the two communication apparatus.

9. A radio communication system as set forth in claim 7, wherein said distance detecting unit detects said distance using impulses with the maximum amplitude and the minimum repetition frequency which can be sent from the communication apparatuses.

10. A radio communication system including a plurality of communication apparatuses which are communicably connected with each other by radio under the UWB (Ultra WideBand)-impulse radio system, said radio communication system comprising:
an electric power detecting unit which detects electric power of impulses which is sent from one of the two communication apparatuses to be connected with each other, of said plurality of communication apparatuses, and is received by the other of the two communication apparatuses;
an impulse adjusting unit which adjusts the amplitude and the repetition frequency of impulses, used in radio communication between the two communication apparatuses, according to the electric power detected by said power detecting unit.

11. A radio communication system as set forth in claim 10, wherein said impulse adjusting unit (i) reduces the repetition frequency when increasing the amplitude of the impulses according to said electric power, and (ii) increases the repetition frequency of the impulses when reducing the amplitude of the impulses according to said electric power.

12. A radio communication system as set forth in claim 10, wherein said power detecting unit detects electric power of impulses with the maximum amplitude and the minimum repetition frequency which can be sent from the communication apparatuses, said impulses being sent from said one of the communication apparatus.

13. A radio communication system including a plurality of communication apparatuses which are communicably connected with each other by radio under the UWB (Ultra WideBand)-impulse radio system, said radio communication system comprising:
a minimum amplitude detecting unit which detects the minimum amplitude of impulses which can be received by one of the two communication apparatus to be communicably connected with each other by radio, of said plurality of communication apparatuses, said impulses being sent from the other of the two communication apparatuses;
an impulse adjusting unit which adjusts the amplitude and the repetition frequency of impulses used in radio communication between the two communication apparatuses according to the minimum amplitude of impulses detected by said minimum amplitude detecting unit.

14. A radio communication system as set forth in claim 13, wherein said impulse adjusting unit sets the amplitude of impulses used in radio communication between the two communication apparatuses to a value greater than the minimum amplitude detected by said minimum amplitude detecting unit.

15. A radio communication system as set forth in claim 13, wherein said minimum amplitude detecting unit attenuates, in stages, the amplitude level of impulses sent from said one of the communication apparatuses, and detects said minimum amplitude as an amplitude of an impulse which has been sent from said one of the communication apparatuses immediately before said the other communication apparatus becomes unable to correctly receive an impulse sent from said one of the communication apparatus.

16. A radio communication system as set forth in claim 15, wherein said impulse adjusting unit sets the amplitude impulses used in radio communication between the two radio communication apparatuses to an amplitude which is greater by one stage than the amplitude of the impulse detected by said minimum amplitude as the minimum amplitude.

17. A radio communication system as set forth in claim 15, wherein said minimum amplitude detecting unit uses an impulse with the maximum amplitude and the minimum repetition frequency, which can be sent from said one of the communication apparatus, as an impulse initially sent from said one of the communication apparatus.

18. A communication apparatus for use in a radio communication system in which communication is carried out under the UWB (Ultra WideBand)-impulse radio system, said apparatus comprising:
a distance detecting unit which detects the distance from another communication apparatus with which communication is to be performed; and
an impulse adjusting unit which adjusts the amplitude and the repetition frequency of impulses used in radio communication with said another communication apparatus according to the distance detected by said distance detecting unit.

19. A communication apparatus for use in a radio communication system in which communication is carried out under the UWB (Ultra WideBand)-impulse radio system, said apparatus comprising:
an electric power detecting unit which detects electric power of impulses which is sent from said another communication apparatus with which communication is to be performed; and
an adjusting unit which adjusts the amplitude and the repetition frequency of impulses used in radio communication with said another communication apparatus with which communication is to be performed, according to the electric power detected by said electric power detecting unit.

20. A communication apparatus for use in a radio communication system in which communication is carried out under the UWB (Ultra WideBand)-impulse radio system, said apparatus comprising:
a minimum amplitude detecting unit which detects the minimum amplitude of impulses which can be received by said another communication with which communication is to be performed; and
an impulse adjusting unit which adjusts the amplitude and the repetition frequency of impulses used in radio communication with said another communication apparatus with which communication is to be performed, according to the minimum amplitude detected by said minimum amplitude detecting unit.
